(19) United States
(12) Patent Application Publication
(10) Pub. No.: US 2023/0276824 A1
(43) Pub. Date: Sep. 7, 2023

(54) A METHOD FOR IMPROVING THE PROTEINACEOUS FIBRE STRUCTURE OF A TEXTURED VEGETABLE PROTEIN PRODUCT, METHODS OF CONTROLLING THE MOUTHFEEL OF A TEXTURED PROTEIN, AND TEXTURED VEGETABLE PROTEIN PRODUCTS

(71) Applicant: VALIO OY, Helsinki (FI)

(72) Inventors: Jingwei LIU, Helsinki (FI); Zhongqing JIANG, Helsinki (FI); Maija ITKONEN, Helsinki (FI); Anni Katriina NISKAKOSKI, Helsinki (FI); Samuel MCCORMICK, Espoo (FI)

(21) Appl. No.: 18/009,786

(22) PCT Filed: Jun. 11, 2021
(86) PCT No.: PCT/EP2021/065824

§ 371 Date: Dec. 12, 2022

(30) Foreign Application Priority Data
Jun. 12, 2020 (FI) 20205618

(51) Int. Cl. A23J 3/22; A23J 3/26; A23J 3/16; A23J 3/18

(52) U.S. Cl. CPC A23J 3/227; A23J 3/26; A23J 3/16; A23J 3/18

(57) ABSTRACT

A method for improving the proteinaceous fibre structure of a textured vegetable protein product, methods of controlling the mouthfeel of a textured protein, and textured vegetable protein products. In the method for improving the proteinaceous fibre structure of a textured vegetable protein product, an extrudate is prepared with an extruder configured to carry out low-moisture protein texturization extrusion, the extrudate including a proteinaceous fibre structure having expansion-related cavities, such as air bubbles, between the proteinaceous fibres; after the extrusion, the extrudate is compressed or compacted in a manner leaving the proteinaceous fibres of the extrudate substantially intact. The compressing or compacting is sustained over a period that causes an irreversible reduction in the size of the expansion-related cavities between the proteinaceous fibres, and preferably also an increase in the bonding between the proteinaceous fibres.

### FIELD OF THE INVENTION

The invention is in the field of textured vegetable protein products.

### BACKGROUND ART

In an article in Handbook of Food Proteins, edited by G. O. Phillips and P. A., the author of the article M. N. Riaz mentions that the United States Department of Agriculture (USDA) has in 1971 defined textured vegetable protein products as “food products made from edible protein sources and characterized by having a structural integrity and identifiable structure such that each unit will withstand hydration and cooking, and other procedures used in preparing the food for consumption”.

In the following, we use the expression “textured vegetable protein product”. In the literature, textured vegetable protein products, also known as TVP, belong to the group of textured protein products. Textured vegetable protein products are made with protein texturization extrusion, which is different from the extrusion technology used to manufacture starch morning cereal extrusion.

Objective of the Invention

The inventors have found that textured vegetable protein products made using currently existing low moisture extrusion texturization technology lack of sufficient structural integrity, boiling resistance, and cooking resistance in comparison to meat products. For example, conventionally, meat analogues made using low moisture extrusion have a sponge-like texture after being hydrated and cooked. Their mouthfeel is overly soft at the initial biting, while uneasy to completely mince the fibres in mouth, eventually, and unlike cooked meat texture.

A first objective of the invention is to improve structural integrity and cooking resistance of textured vegetable protein products (which preferably are textured vegetable protein products). This objective can be achieved with the method according to claim 1 and with the textured vegetable protein product according to claim 39.

A second objective of the invention is to improve the control of mouthfeel and to improve the structural integrity and cooking resistance of textured vegetable protein products made using low moisture extrusion texturization technology. This objective can be achieved with any of the methods according to independent claims 31, 32, 33, 34, 35, 36, 37, 38, either alone or in any combination with one or more of the other independent claims, and with any one of the textured vegetable protein products according to parallel independent claims 41, 42, 43, 44, 45, 46, 47, 48, 49 either alone or in any combination with one or more of the other independent textured vegetable protein product claims. In the priority application, the aim of the invention was to improve structural integrity and cooking resistance. Example 9 which has been added to the present filing after the priority filing contains the samples that we disclosed in the previously disclosed examples. The initial idea of the supplementary information was to study the microstructure of the samples and the mechanisms why they showed an improved structural integrity. The improvement in texture is connected to the integrity, which has been investigated more thoroughly during the drafting of the present application.

A third objective of the invention is to increase the versatility of the mouthfeel of a textured vegetable protein product. This objective can be achieved with the textured vegetable protein product according to claim 50 and claim 51.

The dependent claims describe advantageous aspects of the methods and of the textured vegetable protein products.

### Advantages of the Invention

In the method for improving the proteinaceous fibre structure of a textured vegetable protein product, an extrudate is prepared with an extruder configured to carry out low-moisture protein texturization extrusion, the extrudate comprising a proteinaceous fibre structure having expansion-related cavities, such as air bubbles, between the proteinaceous fibres. After the extrusion, the extrudate is further compressed or compacted in a manner leaving the proteinaceous fibres of the extrudate substantially intact,

whereby:
i) the compressing or compacting is carried out
   a) before the proteinaceous phase completes its curing or undergoes a glass transition from the liquid-like to solid state, and/or
   b) before the extrudate is allowed to cool and also before the extrudate is allowed to dry after the extrusion, and/or
   c) while the extrudate is still at an elevated temperature and has an elevated humidity after the extrusion, and/or
   d) within 60 s, preferably within 15 s, from the extrudate exiting the extruder die, and/or
   e) within 48 h, preferably 36 h, more preferably 24 from the extrudate exiting the extruder die, if the extrudate is kept in a steaming environment having a temperature and humidity so chosen that the product neither substantially cools nor substantially dries between exiting the extruder die and the compression or compacting
and
ii) the compressing or compacting is sustained over a period that causes an irreversible reduction in the size of the expansion-related cavities between the proteinaceous fibres and preferably also an increase in the bonding between the proteinaceous fibres.

The inventors have found that the structural integrity and cooking resistance of the textured vegetable protein product will be improved in a surprising manner. The textured vegetable protein product manufactured with low moisture texturization extrusion will surprisingly lose its sponge-like texture substantially and have improved meat-muscle like chewy texture (mouthfeel). A further surprising difference is that the textured vegetable protein product will have improved cooking resistance characteristics. For example, during cooking, the textured vegetable protein product absorbs water slower and less and remains dryer in the middle of the extrudate. The improved meat-muscle-like chewy texture can be seen in X-ray results about the fibrous structure in which the fibres have become wider. Between the priority filing and the present filing, the inventors have obtained confirming evidence of tasting experience of the products.

Preferably, the compressing or compacting is carried out by using a compressive rheology pressing method. The compressive rheology pressing method may be selected not to cause shear forces in the bulk material, except shear forces that may result from twisting, and/or it may be selected not to break the bonding in the proteinaceous fibre matrix.

Compressive rheology pressing is a recent term used to describe the behaviour of

twin-phase systems of, generally, particles of solids in liquid under the influence of compressive rather than shear forces.

Textured vegetable protein products immediately and within a short time window after the extrusion are twin-phase systems. After the extrusion, there will be the following phase changes completed fast after the extrusion: First, in the protein matrix, the melted proteinaceous material changes from liquid-like phase to solid phase. Second, the water changes from liquid-like water to evaporated water that is present in (which actually is one of the major reasons for the formation of) the expansion-related cavities that in conventional low-moisture extrudates are normally present as air bubbles. It may be essential that the compressing or compacting step is carried out before change of the melted proteinaceous material from liquid-like phase to solid phase and/or the water from liquid-like water to evaporated water that is present in the expansion-related cavities will be completed.

The inventors have obtained very good results when the compressing or compacting is carried out before the extrudate is cooled or allowed to cool below 40 C, preferably before the extrudate is cooled or allowed to cool below 50 C. Without wishing to be bound by a theory, it is expected that this limit temperature is related to the glass transition temperature in which the melted proteinaceous material (which is more liquid-like, flexible) changes to solid phase (which is more solid, more brittle and harder).

Furthermore, the inventors have found out that the time window can be extended to facilitate industrial production. The extending of the time window may be carried out by slowing down or preventing the phase changes. For example, the extrudate may between exiting the extruder die and the compression or compacting be preserved in a steaming environment having a temperature and humidity so chosen such that the product does not substantially cool and dry between exiting the extruder die and the compression or compacting.

Examples of compressive rheology pressing methods include pressing through rolls, twin-belt or plates. Extruding and kneading cause excessive shear forces so that they do not belong to the group of compressive pressing methods. It is essential to have compression while having no or only a minimum of shear forces present, or at least not to have excessive shear forces present.

The compressive rheology pressing method is preferably selected not to cause shear forces in the bulk material, except shear forces that result from twisting. This helps to avoid disturbing (such as, cracking or breaking) the substantially linearly oriented arrangement of the proteinaceous fibres.

The compressing or compacting may be carried out by causing a pressure larger than 60 psi, a pressure larger than 85 psi, a pressure larger than 115 psi, or a pressure larger than 300 psi. The effect of the increased pressure is that (a) the extrudate can be compressed to desired low thickness or high density, (b) the neighbouring proteinaceous fibres can get sterically closer to each other, or get into touch with each other, and (c) the pressure causes an irreversible reduction in the size of expansion-related cavities between the proteinaceous fibres and, preferably, also an increase in the bonding between the proteinaceous fibres.

The compressing or compacting may be set as targeting at a compression gap to be 6-15%, preferably 7-14%, more preferably 8-13%, of the thickness of the extrudate before compressing or compacting. The effect of such compression gap is that the neighbouring proteinaceous fibre can get spatially closer to each other, or get direct into touch with each other, and such compression gap causes an irreversible reduction in the size of expansion-related cavities between the proteinaceous fibres and preferably also an increase in the bonding between the proteinaceous fibres, improves the intactness of the extrudate structure and improves the cooking resistance.

Alternatively, the compressing or compacting may be set as targeting at a compression gap to be 20%-42, preferably 25-39%, more preferably 30-36%, of the extruder die assembly outlet diameter, or of the smallest dimension of the extruder die assembly outlet. The effect of such compression gap is that the neighbouring proteinaceous fibre can get spatially closer to each other, or get direct into touch with each other, and such compression gap causes an irreversible reduction in the size of expansion-related cavities between the proteinaceous fibres and preferably also an increase in the bonding between the proteinaceous fibres, improves the intactness of the extrudate structure and improves the cooking resistance.

The compressing or compacting force may be selected so that the compression or compacting is carried out in manner preventing the extrudate to substantially expand after the compression or compacting, such that the expansion of the textured vegetable protein product from 1 min after compressing or compacting to 2 h after compacting or compressing is at most 15%, preferably at most 9%, more preferably at most 3%, and even more preferably at most 1%, of its thickness. The effect of such compression is that the neighbouring proteinaceous fibres can get spatially closer to each other, or get direct touching with each other, and such compression causes an irreversible reduction in the size of expansion-related cavities between the proteinaceous fibres and preferably also an increase in the bonding between the proteinaceous fibres, improves the intactness of the extrudate structure and improves the cooking resistance.

The extrudates from the extruder outlet may be separated or kept apart from each other before and the compression or compacting and kept apart during the compression or compacting.

The extrudates from the extruder outlet may be laminated, stacked, or aggregated in more than one particle or strand before and during the compression or compacting, such that the compression or compacting attaches the extrudates to each other. The advantage of the extrudates being laminated, stacked, or aggregated is that the extrudates being laminated, stacked, or aggregated may have more layers of structure, richer texture, closer to the shape and thus a texture closer to texture of a chunk piece of meat. The inventors believe it may be possible to find further new uses for the laminated, stacked, or aggregated extrudates.

The extrudate may between exiting the extruder die and the compression or compacting be preserved in a steaming environment having a temperature and humidity so chosen that the product does not substantially cool and dry between exiting the extruder die and the compression or compacting. This helps to avoid or at least delay the possible loss of compressibility or compactability of the extrudates, which will be caused by cooling, drying and undergoing severe glass transition, hardening, loss the capability of forming bonding between the proteinaceous fibres, loss of capability of irreversibly reduce the size of expansion-related cavities between the proteinaceous fibres, especially in cases when the compression cannot be conducted in short enough time after the extrusion and when there is a need of transferring or buffering between the extrusion and compression.

The compression or compacting may be carried out in a steaming environment having a temperature and humidity so chosen such that the product does not substantially cool and dry between exiting the extruder die and the compression or compacting. This helps to avoid or at least delay the possible loss of compressibility or compactability of the extrudates, which will be caused by cooling, drying and undergoing severe glass transition, hardening, loss the capability of forming bonding between the proteinaceous fibres, loss of capability of irreversibly reduce the size of expansion-related cavities between the proteinaceous fibres, especially in cases when the compression cannot be conducted in short enough time after the extrusion and when there is a need of transferring or buffering between the extrusion and compression.

The moisture content of the extrudate after the steaming environment may be between 80-120%, preferably 90-110%, more preferably 95-105% of the original extrudate moisture content before the steaming environment. The advantage is that the extrudate will (a) on one hand, remain moist, soft, compressible; (b) on the other hand, avoid becoming substantially hydrated. The extrudate becoming substantially hydrated can result in (b1) sticky surface of the extrudate; (b2) a more fragile proteinaceous fibre structure of the extrudate that gets more easily broken apart during the following compression; (b3) loss of the chewy texture in the end product; (b4) loss of cooking resistance in the end product; (b5) slimy surface in cases when the extrudate contain oat or barley beta-glucan.

The compressing or compacting is carried out in a time window after the extrusion during which the proteinaceous fibres are responsive to pressing, such that the expansion of the textured vegetable protein product from 1 min after compressing or compacting to 2 h after compacting or compressing is at most 15%, preferably at most 9%, more preferably at most 3%, and even more preferably at most 1%, of its thickness. The advantage is that (a) the extrudates being compacted/compressed in this time window will undergo an irreversible reduction in the size of expansion-related cavities between the proteinaceous fibres and, preferably, also an increase in the bonding between the proteinaceous fibres, which consequently have improved structure intactness, and improved cooking resistance; (b) the extrudates being compacted/compressed in this time window is not brittle or crispy, and hence, will not have the proteinaceous structure been cracked broken during compression.

The inventors have surprisingly found out that time window may be extended with the steaming environment described above.

Preferably, the extrudate should be compressed or compacted after the extrusion before the hardness (H_{c}) of the extrudate increases to more than four-fold of the hardness (H₀) measured at 5 s or 15 s after the extrusion. The extrudate is more preferably compressed or compacted after the extrusion before the hardness (H_{c}) of the extrudate increases to more than three-fold of the hardness (H₀) measured at 5 s or 15 s after the extrusion. The advantage is that in this way, (a) the hardness and compression time of the textured vegetable protein product can be controlled in a relatively simple manner; (b) the extrudates being compressed in this condition will undergo an irreversible reduction in the size of the expansion-related cavities between the proteinaceous fibres and, preferably, also bonding between the proteinaceous fibres will be increased, which consequently will result in improved structure intactness and improved cooking resistance; (c) the extrudates being compacted/compressed in this time window are not yet brittle or crispy, and hence, will not have the proteinaceous structure been cracked during compression.

According to a second aspect of the invention, a textured vegetable protein product comprises an extrudate manufactured with low-moisture protein texturization extrusion, having a proteinaceous fibre structure with expansion-related cavities, such as air bubbles, between the proteinaceous fibres. The extrudate has, after the extrusion, been compressed or compacted in a manner leaving the proteinaceous fibres of the extrudate substantially intact but reducing the size of expansion-related cavities between the proteinaceous fibres, and preferably also increased the bonding between the proteinaceous fibres. The textured vegetable protein product may be manufactured with a method according to the first aspect of the invention.

The textured vegetable protein product may be a textured vegetable protein product, preferably such that the vegetable protein comprises at least one (preferably one, two or three) of the following:
soy protein isolate and/or concentrate,
pea protein isolate and/or concentrate,
faba bean protein isolate and/or concentrate,
lentil protein isolate and/or concentrate,
chick pea protein isolate and/or concentrate,
mung bean protein isolate and/or concentrate,
oat protein isolate and/or concentrate,
rye protein isolate and/or concentrate,
barley protein isolate and/or concentrate,
lupine protein isolate and/or concentrate,
peanut protein isolate and/or concentrate.

Further, the extrusion may be carried out on a water-based slurry comprising in addition to protein material also bran and/or flour, which preferably comprise starch. These are preferably selected from at least one (preferably one, two, three) of the following: oat flour, oat bran, pea flour, faba bean flour, chickpea flour, corn flour, rice flour.

The expansion-related cavities, (which preferably are air bubbles), preferably have after the irreversible size reduction a width less than 0.5 mm, preferably less than 0.2 mm, more preferably less than 0.1 mm. The inventors assume that this size reduction significantly contributes to the improved mouthfeel, improved firm (dense) and chewy texture (mouthfeel), reduced sponge-like texture, increased density (closer to meat product density), improved structural integrity and improved cooking resistance of the textured protein product. Without willing to be bound by theory, the inventors assume that the reduced size or width of the air bubbles is one of the reasons that prevent the TVP from absorbing water and being hydrated and softened by water.

On page 25 of the priority filing, we already disclosed that it is impossible for conventional low moisture extrusion technology alone to achieve extrudate with high chewiness (high fibre strength, high texturization degree) together with high density.

The expansion-related cavities (which preferably are air bubbles) preferably have after the irreversible size reduction a cross-sectional area in the thickness and length direction of the textured vegetable protein product such that a substantial proportion (such as, 22-96%) of the expansion-related cavities has a cross-sectional area less than 0.03 mm². The inventors assume that this reduction of cross-sectional area in the thickness and length direction significantly contributes to the improved mouthfeel, improved firm (dense), muscle-like and chewy texture (mouthfeel), reduced sponge-like texture, increased density (closer to meat product density), improved structural integrity and improved cooking resistance of the textured vegetable protein product.

The expansion-related cavities (which preferably are air bubbles) have after the irreversible size reduction a width-to-length ratio smaller than 22%, preferably smaller than 15%. The inventors assume that this reduction of width-to-length ration significantly contributes to the improved mouthfeel, improved firm (dense) and chewy texture (mouthfeel), reduced sponge-like texture, increased density (closer to meat product density), improved structural integrity and improved cooking resistance of the textured vegetable protein product.

In the method, the compression may be used to achieve a reduced porosity of the textured vegetable protein product. The inventors assume that this reduction of porosity significantly contributes to the improved mouthfeel of the textured vegetable protein product, the textured vegetable protein product having a less sponge-like texture and improved mouthfeel, firmer biting chewiness, higher structural integrity, and better cooking resistance. Reduced porosity can be defined as a measurable quantity, for example, such that when a sample of the textured vegetable protein product, when analysed using X-ray microtomography, having unit regions having high solid fraction values, such as solid fraction value being no less than 70%.

The compression may be used to produce an uneven, non-homogenous structure in the textured vegetable protein product. The inventors assume this contributes to the improved mouthfeel of the textured vegetable protein product by making the mouth feel more favourable by, for example, making it richer, more diverse, and more natural.

The compression may be used to increase stability of the proteinaceous fibres. In the compression treatment, the proteinaceous fibres will form bunches as wide as 0.5 mm, which is much wider than the separated and narrow proteinaceous fibres in extrudate. This improves the soaking and cooking resistance of the textured vegetable protein product and so improves the versatility of the textured vegetable protein product. This also improves the meat-muscle-like, firm (dense) and chewy texture (mouthfeel) of the textured vegetable protein product, reduces its sponge-like texture, increases its density to be closer to meat product density, and improves its structural integrity.

The compression may be used to bundle the proteinaceous fibres together, and/or to laminate the proteinaceous fibres between each other. In the compression treatment, the proteinaceous fibres will form bunches as wide as 0.5 mm, which is much wider than the separated and narrow proteinaceous fibres in the extrudate without the compression treatment. This improves the soaking and cooking resistance of the textured vegetable protein product and so improves the versatility of the textured vegetable protein product. This also improves the meat-muscle-like, firm (dense) and chewy texture (mouthfeel) of the textured vegetable protein product, reduces its sponge-like texture, increases its density to be closer to meat product density, and improves its structural integrity.

In the method, according to the second aspect of the invention, of controlling the mouthfeel of a textured vegetable protein product,
the mouthfeel of a textured vegetable protein product may be controlled by causing an irreversible size reduction of expansion-related cavities, such as air bubbles, such that the expansion-related cavities, such as air bubbles, have after the irreversible size reduction a width less than 0.5 mm, preferably less than 0.2 mm, more preferably less than 0.1 mm

and/or
the mouthfeel of a textured vegetable protein product is controlled by causing an irreversible reduction of a cross-sectional area of expansion-related cavities—such as air bubbles—in the thickness and length direction of the textured vegetable protein product, such that a substantial proportion—preferably between 22% and 96%—of the expansion-related cavities has a cross-sectional area less than 0.03 mm²

and/or
the mouthfeel of a textured vegetable protein product is controlled by causing an irreversible reduction of a width-to-length ratio in the expansion-related cavities—such as air bubbles—which is smaller than 22%, preferably smaller than 15%

and/or
the mouthfeel of a textured vegetable protein product is controlled by irreversibly reducing porosity of the textured vegetable protein product by post-extrusion compression of the textured vegetable protein product

and/or
the mouthfeel of a textured vegetable protein product is controlled by generating regions in the textured vegetable protein product has unit regions having high solid-fraction values when analysed using X-ray microtomography, for example such that the high solid fraction values being no less than 70%

and/or
the mouthfeel of a textured vegetable protein product is controlled by producing, after the textured vegetable protein product is extruded, by producing an uneven, non-homogenous structure in the textured vegetable protein product

and/or
the mouthfeel of a textured vegetable protein product is controlled, after extrusion, by increasing stability of the proteinaceous fibres.

and/or
the mouthfeel of a textured vegetable protein product is controlled after extrusion i) by bundling the proteinaceous fibres together and/or to ii) laminating the proteinaceous fibres between each other.

Respectively, a textured vegetable protein product according to the second aspect of the invention may comprise:
a) an extrudate manufactured with low-moisture protein texturization extrusion, having a proteinaceous fibre structure with expansion-related cavities, such as air bubbles, between the proteinaceous fibres; and
b) wherein the extrudate has, after the extrusion, been compressed or compacted in a manner leaving the proteinaceous fibres of the extrudate substantially intact but reducing the size of the expansion-related cavities between the proteinaceous fibres, and preferably also increased the bonding between the proteinaceous fibres.

The expansion-related cavities preferably have a width-to-length ratio which is smaller than 22%, preferably smaller than 15%.

Alternatively or in addition to this,
the expansion-related cavities may have after the irreversible size reduction a width less than 0.5 mm, preferably less than 0.2 mm, more preferably less than 0.1 mm
and/or
a substantial proportion—preferably between 22% and 96%—of the expansion-related cavities, such as air bubbles, have after the irreversible size reduction a cross-sectional area in the thickness and length direction of the textured vegetable protein product which is less than 0.03 mm².

A textured vegetable protein product according to second aspect of the invention is an extrudate manufactured with low-moisture protein texturization extrusion, having a proteinaceous fibre structure with expansion-related cavities, such as air bubbles, between the proteinaceous fibres. The textured vegetable protein product has a reduced porosity. The reduced porosity can be determined, if a sample of the textured vegetable protein product, when analysed using X-ray microtomography, has unit regions having high solid fraction values, such as solid fraction value being no less than 70%.

A textured vegetable protein product according to second aspect of the invention is an extrudate manufactured with low-moisture protein texturization extrusion, having a proteinaceous fibre structure with expansion-related cavities, such as air bubbles, between the proteinaceous fibres. The textured vegetable protein product has unit regions having high solid-fraction values when analysed using X-ray microtomography, for example such that the high solid fraction values being no less than 70%.

A textured vegetable protein product according to second aspect of the invention is an extrudate manufactured with low-moisture protein texturization extrusion, having a proteinaceous fibre structure with expansion-related cavities, such as air bubbles, between the proteinaceous fibres. The textured vegetable protein product has an uneven, non-homogenous structure in the textured vegetable protein product.

A textured vegetable protein product according to second aspect of the invention is an extrudate manufactured with low-moisture protein texturization extrusion, having a proteinaceous fibre structure with expansion-related cavities, such as air bubbles, between the proteinaceous fibres. The proteinaceous fibres have an increased stability.

A textured vegetable protein product according to second aspect of the invention is an extrudate manufactured with low-moisture protein texturization extrusion, having a proteinaceous fibre structure with expansion-related cavities, such as air bubbles, between the proteinaceous fibres. The proteinaceous fibres have been post-extrusion treated i) by bundling the proteinaceous fibres together and/or to ii) laminating the proteinaceous fibres between each other.

According to third aspect of the invention, the versatility of the mouthfeel of the textured vegetable protein product can be improved if, a textured vegetable protein product has a) a fibrous protein structure which as dry has a crisp-like mouthfeel and as soaked has a mouthfeel of muscle-like fibers or fiber-bunches, such as resembling beef jerky or dried pork and/or b) a fibrous protein structure which during initial biting and cracking in mouth (stage 1) has a crunchy chewy mouthfeel offering bite-resistance, and during continued chewing and mixing with saliva (stage 2) changes to mouthfeel of muscle-like fibers or fiber-bunches, such as resembling beef jerky or dried pork.

The thickness of the textured vegetable protein product may be between 0.5 and 2.0 mm, preferably between 1.0 mm and 2.0 mm.

The textured vegetable protein product may have unit regions having high solid-fraction values when analyzed using X-ray microtomography, preferably such that the high solid fraction values being no less than 70%.

Preferably, the textured vegetable protein product is an extrudate manufactured with low-moisture protein texturization extrusion, having a proteinaceous fibre structure with expansion-related cavities, such as air bubbles, between the proteinaceous fibres. Further preferably, a substantial proportion—preferably between 22% and 96%—of the expansion-related cavities, such as air bubbles, may have after the irreversible size reduction a cross-sectional area in the thickness and length direction of the textured vegetable protein product which is less than 0.03 mm².

The textured vegetable protein product may have a moisture content between 7% and 11% (after the extrusion).

As dry, the textured vegetable protein product can be consumed as a crisp or cracker which is particularly suitable for a “snack” type of meal. As soaked, such as in soup (e.g. instant noodle soup), or if chewed, by the effect of saliva in the mouth, the mouthfeel of the textured vegetable protein product will change to resemble beef jerky or dried pork. Thus, the acceptance of the product be teenagers, in particular, some of which tend to be picky at times, can be improved.

### LIST OF DRAWINGS

In the appended drawings, a number of variations of the method for improving the proteinaceous fibre structure of a textured vegetable protein product are explained in more detail. Of the drawings,

FIG. 1 shows cutting blade measurement results of extrudates after cooking (boiling in water) for 2 min, analysed by a texture analyser equipped with a sharp cutting blade.
The samples in FIG. 1 are:
a: extrudate compressed/compacted at 3 s post-extrusion time,
b: extrudate without post-extrusion compression,
c: semi-dense extrudate produced at semi-high moisture level.

FIG. 2 illustrates the cutting blade measurement arrangement for carrying out the measurements, the results of which are shown in FIG. 1 (1—sample; 2—cutting blade; 3—measurement arm);

FIG. 3 shows parallel plate compression measurement results of extrudates to determine the hardness of the samples. Samples as in FIG. 1;

FIG. 4 illustrates the parallel-plate compression measurement set-up for carrying out the measurements, the results of which are shown in FIG. 3 (1—sample; 4—pressing cylinder; 3—measurement arm);

FIG. 5A to 5D illustrate the parallel-plate compression measurement for carrying out the measurements, the results of which are shown in FIG. 3: FIG. 5A before compression; FIG. 5B compression to 15% of the original sample height, holding at this position for 20 s; FIG. 5C relieving the compression; FIG. 5D the sample partially expanding and recovering;

FIG. 6 weight gain of a textured vegetable protein product sample as a function of cooking time;
The samples in FIG. 6 are:
h: extrudate compressed at 3 s post-extrusion time,
is extrudate compressed at 30 s post-extrusion time,
j: extrudate compressed at 60 s post-extrusion time,
k: extrudate without compression.

FIG. 7 expansion of a textured vegetable protein product sample as a function of cooking time. Samples as in FIG. 6;

FIG. 8 parallel-plate compression measurement of resistance force of extrudates compressed at different post-extrusion times;
The samples in FIG. 8 are:
l: compressed at 15 s post-extrusion time,
m: compressed at 70 s post-extrusion time,
n: compressed at 6 min post-extrusion time,
o: compressed at 12 min post-extrusion time,
p: compressed at 32 min post-extrusion time,
q: compressed at 4 day post-extrusion time.

FIG. 9 parallel-plate compression measurement of resistance force of extrudates stored under different conditions;
The samples in FIG. 9 are:
q: stored in a closed bag and then compressed at 4 day post-extrusion time (the same sample shown in FIG. 8),
r: stored in ambient environment and then compressed at 4 day post-extrusion time.

FIG. 10 parallel-plate compression measurement of resistance force of extrudates with flour recipe B (pea protein 25%, faba bean protein 25%, oat bran 20%, oat flour 10%, oat protein 20% by weight); and
The samples in FIG. 10 are:
B1: extrudate analyzed after 5 s post-extrusion time;
B2: extrudate analyzed after 5 s post-extrusion time followed by 4 min storage in steamer, then analysed immediately;
B3: extrudate analyzed after 5 s post-extrusion time followed by 10 min storage in steamer, then analysed immediately;
B4: extrudate analyzed after 5 s post-extrusion time followed by 4 min storage in steamer, then shock chilled before analysis.

FIG. 11 parallel-plate compression measurement of resistance force of extrudates with recipe A (60% pea protein, 40% oat bran).
The samples in FIG. 11 are:
A1: extrudate analyzed after 5 s post-extrusion time;
A2: extrudate analyzed after 5 s post-extrusion time followed by 10 min storage in steamer, then analysed immediately;
A3: extrudate analyzed after 5 s post-extrusion time followed by 10 min storage in a bag at steaming temperature, then analysed immediately.

FIG. 12A is a photograph of sample #PAN taken by a digital camera, in a view toward the cross-section containing the width and thickness dimensions (also can be regarded as diameter in this cylinder shape product) of the product;

FIG. 12B is a photograph of sample #PAN taken by a digital camera, in a view toward the surface and side-view containing the diameter and length dimensions of the product;

FIG. 12C is a photograph of sample #AC10 taken by a digital camera, in a view toward the top view containing the width and length dimensions of the product;

FIG. 12D is a photograph of sample #AC10 taken by a digital camera, in a view toward the surface and side-view containing the thickness and length dimensions of the product.

FIG. 13A is an X-ray microtomography (Micro-CT) scanning image of sample #AN in a similar view as in FIG. 12B, which is a view containing the diameter and length dimensions of the product. Longer side is the length dimension in FIG. 13A.

FIG. 13B is an X-ray microtomography (Micro-CT) scanning image of sample #AN in a similar view as in FIG. 12A, which is a view containing the diameter dimensions of the product.

FIG. 14A is an X-ray microtomography (Micro-CT) scanning image of sample #AC60 in a view containing the width and length dimensions of the product. Longer side is the length dimension of the extrudate in FIG. 14A;

FIG. 14B is an X-ray microtomography (Micro-CT) scanning image of sample #AC60 in a view containing the thickness and length dimensions of the product. Longer side is the length dimension in FIG. 14B;

FIG. 14C is an X-ray microtomography (Micro-CT) scanning image of sample #AC60 in a view containing the thickness and width dimensions of the product. Longer side is the width dimension in FIG. 14C.

FIG. 15A is an X-ray microtomography (Micro-CT) scanning image of sample #AC10 in a view containing the width and length dimensions of the product. Longer side is the length dimension in FIG. 15A.

FIG. 15B is an X-ray microtomography (Micro-CT) scanning image of sample #AC10 in a view containing the thickness and length dimensions of the product. Longer side is the length dimension in FIG. 15B.

FIG. 15C is an X-ray microtomography (Micro-CT) scanning image of sample #AC10 in a view containing the thickness and width dimensions of the product. Longer side is the width dimension in FIG. 15C.

FIG. 16A is an X-ray microtomography (Micro-CT) scanning image of sample #BN in a similar view as in FIG. 12B, which is a view containing the diameter and length dimensions of the product. Longer side is the length dimension in FIG. 16A.

FIG. 16B is an X-ray microtomography (Micro-CT) scanning image of sample #BN in a similar view as in FIG. 12A, which is a view containing the diameter dimensions of the product.

FIG. 17A is an X-ray microtomography (Micro-CT) scanning image of sample #BC10 in a view containing the width and length dimensions of the product. Longer side is the length dimension in FIG. 17A.

FIG. 17B is an X-ray microtomography (Micro-CT) scanning image of sample #BC10 in a view containing the thickness and length dimensions of the product. Longer side is the length dimension in FIG. 17B.

FIG. 17C is an X-ray microtomography (Micro-CT) scanning image of sample #BC10 in a view containing the thickness and width dimensions of the product. Longer side is the width dimension in FIG. 17C.

FIG. 18A is a microscopic image of sample #BN in a view containing the width and length dimensions of the product. Fibres and darker shade solids represent the proteinaceous fibrous structure of the product. The scale bar is indicated in the FIG. The samples were hydrated with water in a ratio of 1:1 for over 24 hours before the slicing and observation. The samples were stained with light green and iodine to show protein and starch and converted to greyscale images.

FIG. 18B is microscopic image of sample #BC10 in a view containing the width and length dimensions of the product. Fibres and darker shade solids represent the proteinaceous fibrous structure of the product. The scale bar is indicated in the FIG. The samples were hydrated with water in a ratio of 1:1 for over 24 hours before the slicing and observation. The samples were stained with light green and iodine to show protein and starch and converted to greyscale images.

Same reference numerals refer to respective objects in all FIG.

### DETAILED DESCRIPTION

### I Background

The reason for sponge-like texture of conventional low moisture extruded texturized plant protein is that a large amount of water inside the expansion-related cavities textured protein matrix is evaporated immediately when the extrudate comes out from the extruder die. At this point, the temperature of the extrudate is still high (above 100° C.) and the pressure drops immediately. This instant evaporation makes the extrudate expanded (for example, typically, 50-100% increase in volume) and forms a large quantity of visible air cells as well as micro air cells in the extruded products. These air cells are referred to with the expression expansion-related cavities.

The commercial texturized plant protein products that we can commonly find in food market as ingredients for further cooking, are mostly made of soy protein and normally have a spongy and rubbery mouthfeel. In addition, when other legume proteins are used to replace the soy protein, and when cereal materials and starch containing materials are combined with the legume proteins in protein texturization extrusion (low moisture extrusion), the products are often low in density. Furthermore, they are often less dense and have a foamier (airy) structure than those texturized plant protein products made of soy protein. Moreover, all these texturized plant protein products made with low moisture extrusion have more air cells and a lower density than meat products (density 0.1-0.5 g/ml for texturized plant protein products, and around 0.7-1.1 g/ml for meat).

According to currently available knowledge concerning protein texturization extrusion, the density and chewiness (strength of the proteinaceous fibres) of the extrudate are often regulated by the degree of texturization. High temperature, high shearing force, low moisture content during extrusion (liquid feed, ratio between water and solid matter) can often generate a higher chewiness as well as a low density of the extrudate.

In other words, when a high density extrudate is wanted, the persons skilled in the art often choose to increase the liquid feed, decrease the temperature and/or decrease the shearing force in the extruder. As a result, such extrudates will have a softer texture and less cooking resistance (for example, such extrudates tend to dissolve easily in boiling water). Persons skilled in the art may look for a point that high liquid feed and high temperature is used, and the products with a moderate texture (fibre strength) and a moderate density might be produced.

Nevertheless, methods like these do not result in sufficiently meat-like high density, low airy, or chewy products. In addition, increasing the liquid feed during extrusion will lead to an increased energy cost at the production: the increased amount of water in extrusion can increase the heat capacity of the extruded materials and cool down the extruded material, so more heating energy will be needed to achieve the desirable heating effect; the increased amount of water in extrusion can decrease the friction force between the materials and between the materials and the screws, and hence decrease the friction heat and decrease the stability of the production due to the slipperiness; the increased amount of water in extrusion can increase the evaporation vapour pressure inside the extruder chamber and push the materials out from the extruder too early and, hence, decrease the production stability. As a result of these effects, the extrusion production capacity is often lowered by the increased amount of water in extrusion. This is also in agreement with the facts that high moisture protein texturization extrusion normally has lower production capacity than the low moisture protein texturization extrusion carried out on the same extruder. In addition, extrudate produced with higher liquid feed normally needs more energy for drying after extrusion, when storage-quality-demanded moisture content of the extrudate is desired.

All in all, it appears to be technically impossible to find a satisfactory balance between a high density of extrudate and a high chewiness and cooking resistance of extrudate. If such a balance could be achieved, it would be possible to manufacture textured vegetable protein products that would have a density and texture closer to meat. Furthermore, such products would need less steric space of packing, storage and delivery.

### II The Experimental Setup

The experiments in which we were able to demonstrate that the method works were carried out with certain extrusion conditions, namely:
(a) protein texturization low moisture extrusion;
(b) extrusion at extruder die pressure between 0.6 MPa and 10.0 MPa, preferably between 0.8 MPa and 5.0 MPa, more preferably between 1.0 MPa and 4.0 MPa;
(c) material inside extruder (solid raw material together with liquid feed) having total moisture content between 20% and 35% by weight, preferably between 25% and 29% by weight;
(d) the extrudate (extruded product) is expanded right after exiting the extruder outlet (extruder die), meaning that the extrudate cross-section area is a least 10% larger than the cross-section area of the extruder outlet (the extruder die), and the extrudate has at least 10% of its volume cavities (space filled up with air, or space having no solid or liquid material);
(e) the extrudate has a continuous proteinaceous fibrous matrix structure that is substantially linearly oriented, and has empty space (expansion-related cavities that result in air bubbles in the ready product) between the proteinaceous fibres, (the structure features are visible by visual observation and/or by optical microscopic observation);
(f) the extrudate is not cut, or is cut to size no shorter than 2 mm, so the proteinaceous fibres can remain no shorter than 2 mm and can provide chewy texture.

The method comprises an essential processing step after the extrusion, which is the compacting or compressing of the extrudate. The compacting or compressing step, in general, is carried out using physical contacting force to reduce the volume of the extrudate without substantially losing weight. The volume reduction can be conducted in one dimension, for example, reducing the thickness, without significant reduction in length and width. The industrially available methods for implementing this one-dimensional volume reduction compression include rolling, twin-belt pressing and parallel-plate compression. These can be carried out by machinery with mechanism similar to roller mill, dough sheeter, belt press (such as juice belt press). The volume reduction can also be conducted in more than one dimension. For example, the compacting/compression can be two- or three-dimensional. For example, three-dimensional compacting/compression reduces the thickness, width and length of the extrudate. Furthermore, the compacting (volume reduction) can also be conducted together with a twisting mechanism that folds or twists the extrudate before or during the compression.

The compression force applied on the extrudate should be larger than 60 psi, preferably larger than 85 psi, more preferably larger than 115 psi, the most preferably larger than 300 psi. (psi=pound per square inch; 1 psi equals approx. 6895 Pa). The compression should last for a time having compression pressure above 60 psi between 1 s and 10 min, preferably between 3 s and 3 min, more preferably between 5 s and 30 s.

The compacting/compression can be set as targeting at compression gap to be 6-15%, preferably 7-14%, more preferably 8-13% of the extrudate original thickness (thickness before compacting/compression). Alternatively, the compacting/compression can be set as targeting at compression gap to be 20-42%, preferably 25-39%, more preferably 30-36% of the extruder die assembly outlet thickness (diameter, or the smallest dimension).

The compacting/compressing power should preferably be high enough so that the minimum-size-during-compacting (e.g. minimum-thickness-during-compacting in parallel-plate compacting situation) of the extrudate is compacted to lower than the desired (target) size of the final product (after the whole process and 2 day storage). The size-during-compacting should be 1% lowered than the desired (target) size, preferably 5% lowered than the desired (target) size, more preferably 30% less than the desired (target) size.

In one embodiment, the extrudates may be separated apart from each other before and during the compacting/compression. The neighbouring extrudates are kept with distance between each other before and during the compacting/compression. As a result, the compressed extrudates are individual particles or strands.

In another embodiment, the extrudates may be laminated, stacked, or aggregated in more than one particle or strand before and during the compacting/compression. As a result, the compressed extrudates present as firmly attached clusters of more-than-one particles or strands.

The compacting/compression should preferably avoid substantially breaking the proteinaceous fibres of the extrudate, either to shorter, or separate apart from each other. Such linearly oriented proteinaceous fibrous structure can provide desirable muscle meat like texture and boiling resistance properties. This structure and corresponding desirable texture and boiling resistance properties can be substantially strengthened by said compression. On the other hand, when an inappropriate compression method is used, for example, compressing and breaking (mincing or separating) the proteinaceous fibrous structure at the same time, the desirable texture and boiling resistance properties are destroyed. Extrusion methods having substantial shearing force, kneading force, moistening and cooking are, therefore, not suitable for said compression in this invention.

The inventors observed and found that the extrudate has relatively more flexible texture right after extrusion (e.g. post-extrusion time less than 60 s, preferably less than 30 s). After that, with time lapsing from 1 min to 1 h, the extrudates continuously are hardened (more firm, rigid, less available for compressing or twisting) very rapidly. The effect of hardening continues in the following a few days with lower speed than that in the first a few hours.

The inventors have conceived that the extrudate is more prone to retain the shape, structure and size into which it was compressed the sooner the compacting/compression is carried out after extrusion.

The inventors have also surprisingly conceived that the extrudate has an extrudate-extrudate adhesive force on the surface right after extrusion (e.g. post-extrusion time within 30 seconds). For example, the extrudates can be tightly “attached or glued” to each other after they are compacted/compressed together by compressing force. The extrudate-extrudate adhesive force disappears or weakens remarkably soon; the time window during which the adhesive force disappears or weakens is normally from 3 s to 60 s. With the current observation, the inventors assume that there is similar adhesive force between the proteinaceous fibres inside the extrudate. This hypothesis is in agreement with the fact that, after the extrudate is compacted/compressed to 10% thickness of its original thickness within 30 s of post-extrusion time, the extrudate will mostly remain in that thickness without consequent expanding. In other words, in this situation, the proteinaceous fibres become tightly bound to each other after the compacting/compression, and do not separate with time. Such fibre-fibre bonding force (adhesiveness) can also keep the fibre-fibre adhering closely to each other against cooking (water boiling) for, for example, 2 min.

The other changes in properties of the extrudate that take place after extrusion may involve: (1) glass transition and material hardening (related to cooling down); (2) cooling down to ambient temperature; (3) losing moisture and (4) decrease of reacting activity (crosslinking or bonding power) of the components (protein and/or starch). These may be related to the changes of the extrudate texture flexibility, as well as to the extrudate external and internal adhesive forces. They may impact the results together and/or separately in different situations. Nevertheless, the (2) cooling down and (3) losing moisture are very common phenomena in the production of extrudates with low moisture protein texturization extrusion.

The method can be implemented with a process that comprises the processing steps of: (1) mixing of the dry ingredients (protein plus optionally also flour and/or bran) and feeding; (2) liquid feeding; (3) low moisture protein texturization extrusion (liquid feed level below 35%); (4) (optionally) cutting of the extrudate coming out from the extruder; (5) within a short post-extrusion time, shock compacting/compressing the extrudate with a high pressure.

A short post-extrusion time refers to less than 24 h, preferably less than 1 h, more preferably less than 1 min, even more preferably less than 30 s, and most preferably less than 10 s, in most common production situation of low moisture protein texturization extrusion.

The inventors surprisingly found that an extrudate remains soft, has a significant material surface adhesiveness and a good capability of keeping the reformed structure if it is
(a) when right after the extrusion (within 60 s, preferably within 30 s post-extrusion time, more preferably within 10 s post-extrusion time),
(b) kept in a steaming environment having
   (b1) high temperature (e.g. above 80 C, preferably above 95 C) and
   (b2) high humidity (as high as in a steamer, for example, relative humidity above 60%, preferably above 70%, more preferably above 90%)

The steaming environment having a high temperature and a high humidity should neither substantially hydrate nor substantially dry the extrudate. The moisture content of the extrudate after the steaming process should remain 80-120%, preferably 90-110%, more preferably 95-105% of the original extrudate moisture content before the steaming process.

The steaming environment can be used as a buffering storage stage between the extrusion and the compacting/compression. More preferably, said steaming environment can be used as a conveying system linking the extrusion and the compression. In other words, the conveying system linking the extruder and the compressor can be equipped to provide such high temperature and high humidity. In this case, the post-extrusion time before the extrudate enters the steaming environment becomes possible to be lower than 1 s, which is preferable for achieving good compression effects easily; the post-steaming time before the extrudate enters the compressor becomes possible to be lower than 1 s, which is preferable for achieving good compression effects easily. Said conveying system with high temperature and high humidity can be pneumatic conveying system with elevated temperature and humidity. Said conveying system with high temperature and high humidity can also be belt or rotary conveying system with elevated temperature and humidity.

The elevated temperature and humidity conditions can be facilitated (a) by attaching an additional hot steam generator, which inputs hot steam into the space of the storage or conveying system; or (b) by attaching an additional steam generator and additional heating elements, which input, respectively, steam and heat into the space of the storage or conveying system. Furthermore, and more preferably, the elevated temperature and humidity conditions can be facilitated by directing the hot steam generated by the extruder during the low moisture extrusion, coming out together with the extrudate, into a preferably closed and heat-insulated space of the storage or conveying system. Typically, conventionally, such hot steam from the low moisture extrusion is treated or condensed as waste. The low moisture extrusion is typically conducted at a very high temperature and high pressure, e.g. between 160° C. and 195° C., which can result in quick substantial evaporation of water from the extrudates into steam when they exit the extruder die outlet.

The inventors surprisingly found that, when the steaming environment is replaced to (a) heating and open environment without elevated humidity, or is replaced with (b) heating and closed environment without elevated humidity, the extrudate loses the compressibility quickly, and turn to be incompatible for producing a highly compressed extrudate. The elevated humidity can better preserve the moisture content level of the extrudate than the closed environment does, though the elevated humidity should not increase the moisture content of the extrudate. The reason for this special requirement of the elevated humidity can be related to the high temperature or heating history of the extrudate that make the extrudates dry fast or have fast water mobility within the extrudate structure.

The post-steaming time before compression (in case of entering the steaming process within short post-extrusion time) has similar trend and limit as the post-extrusion time before compression (in case of compression is conducted as the post-extrusion without steaming in between). —See the results in Experiments below.

The inventors surprisingly found that, after the steam treated extrudate is quickly chilled to room temperature without changing the moisture content, the extrudate loses the compressibility immediately, and turn to be incompatible to produce the highly compressed extrudate. This indicates that prevention of drying alone is not sufficient for maintaining the compressibility of the extrudates.

There are a number of advantages of this invented process and products thereof, for example:
structural integrity and cooking resistance of the extrudate can be remarkably improved;
extrudate with high density, high chewiness and good cooking resistance can be produced; closer to meat density and meat texture,
extrudate with high density can be produced with low level of liquid feed and high production efficiency (capacity and energy efficiency)
extrudate with satisfactory balance point between high density (of extrudate) and high chewiness (and cooking resistance, of extrudate), which helps to save steric space of packing, storage and delivery.

Substantial hydrating of the extrudate before compacting/compressing is unfavourable, and should be avoided, because the extrudates get sticky on the surface after they are substantially hydrated. Furthermore, a substantial hydration makes the proteinaceous fibre structure materials of the extrudate less intact and the proteinaceous fibres are more easily broken apart during the following compacting/compression, and tend to lose the desirable chewy texture and cooking resistance. Extrudates containing beta-glucan from oat and/or barley tend to get slimy on the surface after they are substantially hydrated and then compressed.

### III Methods, Experiments and Results

### Experiment 1

### Production of the Shock-Compacted Texturized Plant Protein Extrudate (Recipe 1)

Experiment procedure: Mixing of dry ingredients [symbol] Low moisture extrusion [symbol] compression [symbol] packing & evaluation Step 1: Mixing of dry ingredients (protein, optionally also flour and/or bran): Recipe 1. Legume protein flour mix (a mixture of protein isolate and protein concentrate of pea and faba bean) 65%, and oat bran 35%. Thorough mixing.

Step 2: Low moisture extrusion condition: The equipment and settings are typical and known in the art, for example, as disclosed in European patent 3361880 B1. Some key features: twin-screw extruder equipped with a low-moisture extrusion extruder die assembly, length of the die assembly preferably 10-20 cm, diameter of the outlet on the die assembly preferably 5 mm.

Extrusion at screw speed of 300 rpm and temperatures profile 60° C.->180° C.->130° C. used in six temperature sections. Production rate 30-40 kg/h. Powder ingredients are fed from the solid feeder to the starting portal of the screws (temperature section 1). The water (tap water) is fed at temperature section 2. The moisture content of the extruded material during extrusion (a sum of moisture from the powder ingredients and moisture from the liquid feeder) was controlled (by setting the liquid feeder feeding rate) to be 22-26%, preferably close to 24%.

Step 3: Compacting/Compression: Extrudate coming out from die holes (diameter=5 mm) expanded instantly to diameter of 9.5-10.5 mm. Then, samples were collected; 5 s after extrusion, these samples were compressed using Manual Dough Press Machine. Compression pressure and time applied on the extrudate was around 86-115 psi for 5 s. After compression, the extrudate thickness was reduced to 1.6-2.0 mm (thickness reduction 80%-85%).

In order to investigate the effect of post-extrusion time on the compression result, the compression process was conducted at different post-extrusion time (for example, 3 s, 10 s, 30 s, 60 s, 80 s) with the same compression force.

The density of the extrudates was analysed by weighing and volume measurement. The dimensions of the extrudate were measured with a Vernier caliper.

TABLE 1
Density of different compressed extrudates
and non-compressed samples

| | “as is” | Computed Water- |
|---|---|---|
| | Density | free Density |
| | (g/cm³) | (g/cm³) |
| Extrudate compressed at 3 s | 0.87 | 0.77 |
| post-extrusion time | | |
| Extrudate compressed at 30 s | 0.45 | 0.40 |
| post-extrusion time | | |
| Extrudate compressed at 60 s | 0.32 | 0.28 |
| post-extrusion time | | |
| Non- compressed extrudate | 0.16 | 0.14 |
| Semi-dense extrudate produced | 0.34 | 0.30 |
| at semi-high moisture level* | | |
| Meat (in literature) | 0.7-1.1 | 0.18-0.28 |
| Low moisture extrusion | 0.1-0.5 | |
| produced texturized plant | | |
| protein (in literature) | | |

*Semi-dense extrudate produced at semi-high moisture level, “sample 1”, extrudate produced by low moisture extrusion, with extrusion moisture content close to the higher limit of low moisture extrusion, moisture content of the extruded material during extrusion 27-34%, preferably close to 28.5%. The semi-dense extrudate represents extrudates that have the highest density typically achievable with the conventional low-moisture extrusion production.

Table 1 shows that: (a) extrudate compressed at short post-extrusion time (3 s) can produce ultra-high density extrudate that is much denser than the non-compressed extrudate; (b) the shorter post-extrusion time to conduct the compression, the higher density can be achieved; (c) high density extrudate can be closer to the density of meat muscle products.

Evaluation of the Products in Experiment 1: Texture after Water Boiling Test

The extrudates were kept in a mesh cage and immersed in boiling water for 2 min. Then the cooked extrudate were evaluated with a texture analyser equipped with a cutting blade, in order to analyse their texture (bite resistance). The blade moved downward to cut 99.9% of the thickness of the extrudates.

For the Cutting Force measurement, we measured the resistance forces of the samples during a compression test with a knife blade. The measurements were carried out so that the TA.XTPlus Texture Analyzer (supplier Stable Micro Systems) was equipped with a 294.2 N (30 kg) load cell (detector sensor) and a sharp knife blade. The knife is “double bevel (grind) Scandi” type. The knife has a blade having a total wedge angle of approximately 16 degree at the sharpest part (edge), which means the knife's primary angle of bevel is approximately 8 degree. The knife has a flat part (spine) with 0.6 mm thickness being above the blade part. The height of the samples were between 2.0 and 12.0 mm. The width of the sample was approximately 10 mm. The samples were stabilized and put horizontally on a plate and the direction of the sample was adjusted to let the blade compress (i.e. cut) towards the cross-section direction of the elongated fibre (in the length direction of the fibre). The downward speed before the blade touching the fibre was 4 mm/s (pre-test speed). The speed of compression when the blade touched the fibre was 20 mm/second (test speed) and compression went to a cutting depth until 99.9% of the height of the sample was reached. The peak positive force (peak positive force is a term used in the equipment software, it refers to the largest force detected during the measurement) was taken as the Cutting Force for this study.

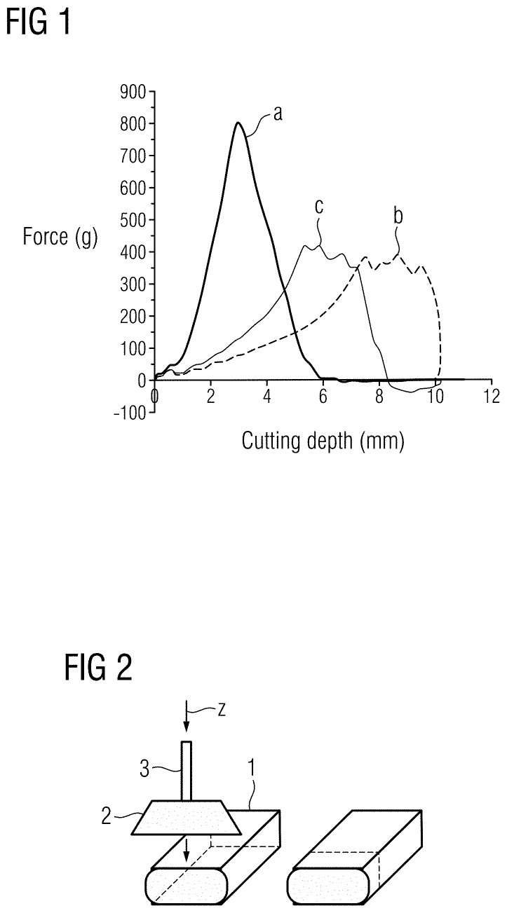

FIG. 1 shows the measurement results texture of the extrudates being cooked (boiled in water) for 2 min, analysed by a texture analyser equipped with a sharp cutting blade (cf. FIG. 2). The flour recipe and compositions of the tested extrudates were the same. The compressed extrudate was compressed with the pizza dough press at 3 s post-extrusion time. Cutting depth was set as 99.9% of the sample thickness auto-detected by the machine (trigger force 5 g). Each curve in the figure shows average values of more than two analysis result curves.

FIG. 1 shows that, after cooking in water, the extrudate compressed at 3 s post-extrusion time had significantly different texture (higher biting/cutting resistance, steeper rise of resistance force since the cutting blade touches the sample, quick decrease of resistance force after the peak positive force is reached) from the other extrudates. Such cutting-related texture is closer to that of some muscle meat foods. For example, in our previous study, cooked chicken thigh meat had cutting force (peak positive) 1066 g, and cooked chicken breast fillet meat had cutting force (peak positive) 974 g. The cutting force (peak positive) of this cooked (boiled) extrudate compressed at 3 s post-extrusion time was around 800 g. The steep rise of resistance force since the cutting blade touches the sample reveals the favourable texture of the product: since consumer's teeth start to touch the product, the consumer can perceive a solid firm resistance texture in mouth right away. The quick decrease of resistance force after the peak positive force is reached is also a favourable texture. The product can be broken apart and close to swallowing after firm bites. In this condition, the mouthfeel is “chewy” and “clear (sharp)”. Nevertheless, the extrudate without compression, had very slow rise of resistance force after the beginning of cutting or biting. Moreover, the extrudate without compression had long lasting semi-high resistance force period. These two features revealed the spongy texture of the extrudate without compression. The consumer's sensorial perception toward this product is that the product last long time soft, doughy and hard to be broken into smaller individual pieces being ready-to-swallow. The semi-dense extrudate produced at semi-high moisture level was also soft and doughy and was even showing clear stickiness (negative force when the cutting blade was withdrawing). The softness, dough-like texture and stickiness are all unfavourable for products to be used as meat analogues.

The same products were also analysed with texture analyser using a different probe and program, which indicates the Hardness, Chewiness and Resilience.

For the Hardness, Chewiness and Resilience measurement, we measured the resistance forces of the samples during a compression test with a cylinder shape probe (model “P/36R”, 36 mm Radius Edge Cylinder probe—Aluminium—AACC Standard probe for Bread firmness, supplier Stable Micro Systems). The measurements were carried out so that the TA.XTPlus Texture Analyzer was equipped with a 294.2 N (30 kg) load cell (detector sensor) and a cylinder shape probe. The height of the samples was between 7.0 and 12.0 mm. The length of the sample was 40 mm. The samples were stabilized and put horizontally on a plate and the direction of the sample was adjusted to let the cylinder compress towards the centre of the sample.

The measurement program was adopted from a standard TPA measurement protocol (Citation from the manual of the measurement equipment “Texture profile analysis (TPA) is an objective method of sensory analysis. TPA is based on the recognition of texture as a multi-parameter attribute. For research purposes, a texture profile in terms of several parameters determined on a small homogeneous sample may be desirable. The test consists of compressing a bite-size piece of food two times in a reciprocating motion that imitates the action of the jaw and extracting from the resulting force-time curve a number of textural parameters that correlate well with sensory evaluation of those parameters. The mechanical textural characteristics of foods that govern, to a large extent, the selection of a rheological procedure and instrument can be divided into the primary parameters of hardness, cohesiveness, springiness (elasticity), and adhesiveness, and into the secondary (or derived) parameters of fracturability (brittleness), chewiness and gumminess.

The downward speed before the probe touching the fibre was 1 mm/s (pre-test speed). The speed of compression when the cylinder probe touched the fibre was 5 mm/second (test speed) and compression went to a compression depth until 70% of the height of the sample was reached. Then the probe withdraws (moves upwards) with speed (post-test speed) 5 mm/second. The peak positive force (peak positive force is a term used in the equipment software, it refers to the largest force detected during the measurement) was taken as the Compression Force for this study. There was a “trigger force” setting, which was set as 5 g in this study. The waiting time between the first and the second compression was 3 s. The Hardness is calculated by the software of the measurement equipment. The Hardness equals to the peak positive force during the first compression.

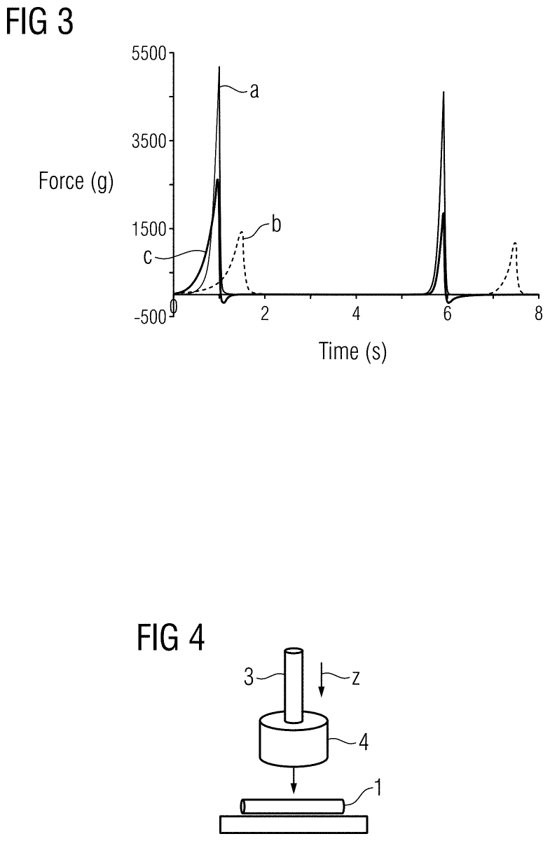

The results are shown in FIG. 3 and listed in Table 2. FIG. 4 illustrates the measurement set-up.

TABLE 2
Results of the Hardness, Chewiness and Resilience measurement

| | Hard- | | | |
|---|---|---|---|---|
| | ness | Adhesiveness | | Resil- |
| | (g) | (g · sec) | Chewiness | ience |
| Extrudate compressed at 3 s | 5246 | −3.5 | 3271 | 0.42 |
| post-extrusion time | | | | |
| Extrudate without | 1352 | −1.1 | 699 | 0.24 |
| compression | | | | |
| Semi-dense extrudate | 2512 | −50.9 | 457 | 0.12 |
| produced at semi-high | | | | |
| moisture level | | | | |

“Hardness” is “Force required for a pre-determined deformation”
“Adhesiveness” is “Work required to overcome the sticky forces between the sample and the probe”
“Chewiness” is “Energy needed to chew a solid food until it is ready for swallowing”
“Resilience” is defined by www.texturetechnologies.com as “a measure of how well a product fights to regain its original position” and is a parameter similar to elasticity. But it is expressed as a ratio of energies instead of a ratio of distances.

The definitions above are taken from Trinh, Khanh Tuoc and Steve Glasgow. Conference Paper. Conference: Chemeca 2012, At Wellington, New Zealand. On the texture profile analysis test.

We further measured water absorption during the cooking test. The results are shown in FIG. 6 and listed in Table 3.

Extrudate compacted/compressed at extremely short post-extrusion time (3 s) absorbed water very much slower and less during cooking (boiling in water) than the other extrudates (without compression or compacted/compressed at later post-extrusion time) did. This is mainly due to the facts that the extrudate compressed at extremely short post-extrusion time had ultra-high integrity of structure, which prevented the water from entering the core of the extrudate structure and hydrating it.

Table 3: Water Absorption in the Cooking Test

Extrudate compressed at extremely short post-extrusion time (3 s) absorbed much less water during cooking (boiling in water for 2 min) than the other extrudates (without compression or compressed at later post-extrusion time). This is mainly due to the fact that the extrudate compressed at extremely short post-extrusion time had ultra-high integrity of structure, which prevented the water from entering the core of the extrudate structure and hydrating it.

Extrudate compressed at very short post-extrusion time (30 s-60 s) absorbed less water during cooking (boiling in water for 2 min) than the extrudate without compression. This is mainly due to the fact that the extrudate compressed at very short post-extrusion time had very high integrity of structure, which prevented the water from entering the core of the extrudate structure and hydrating it.

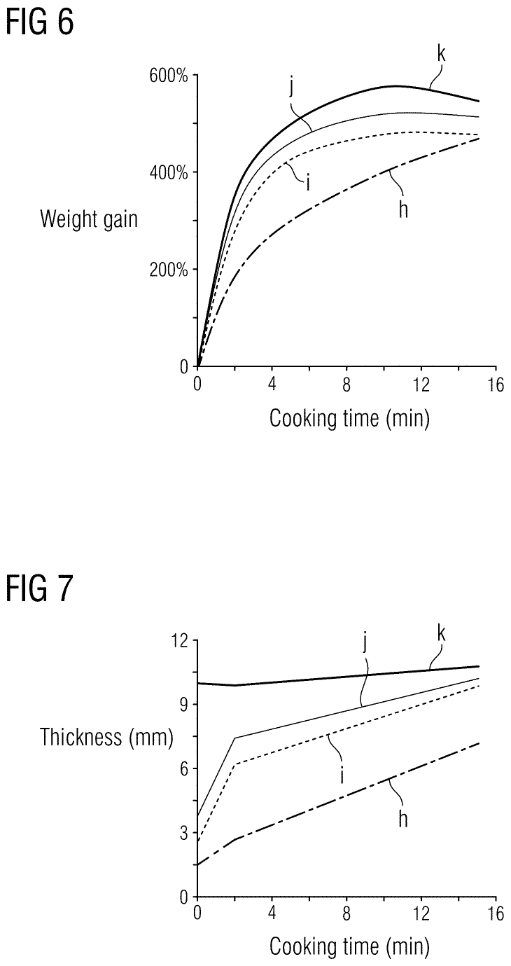

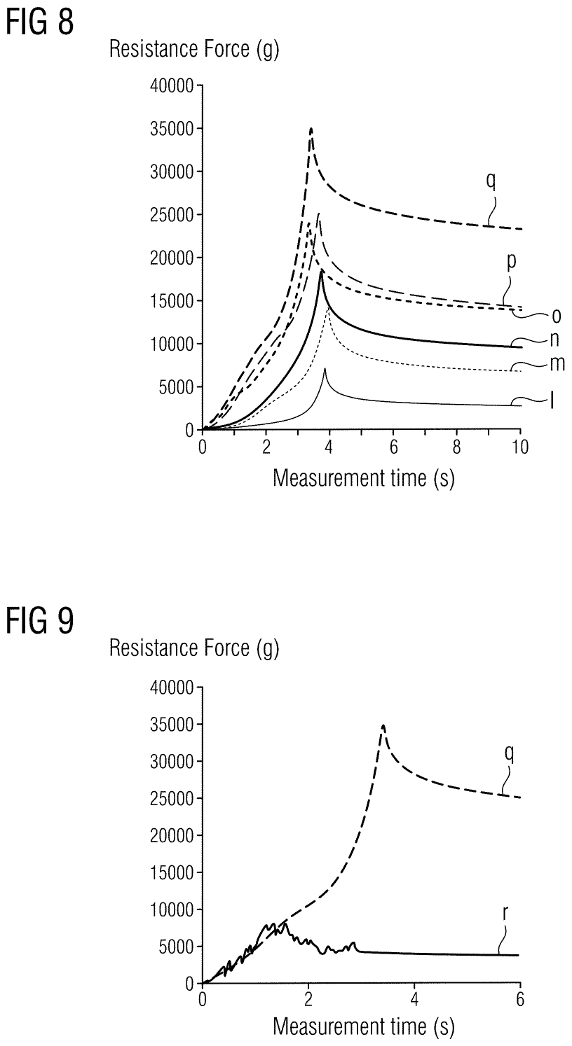

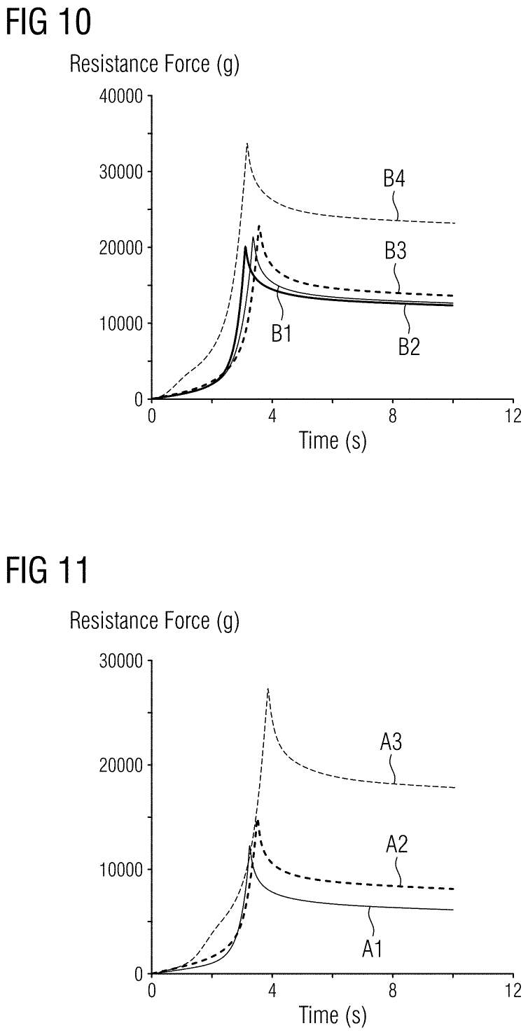

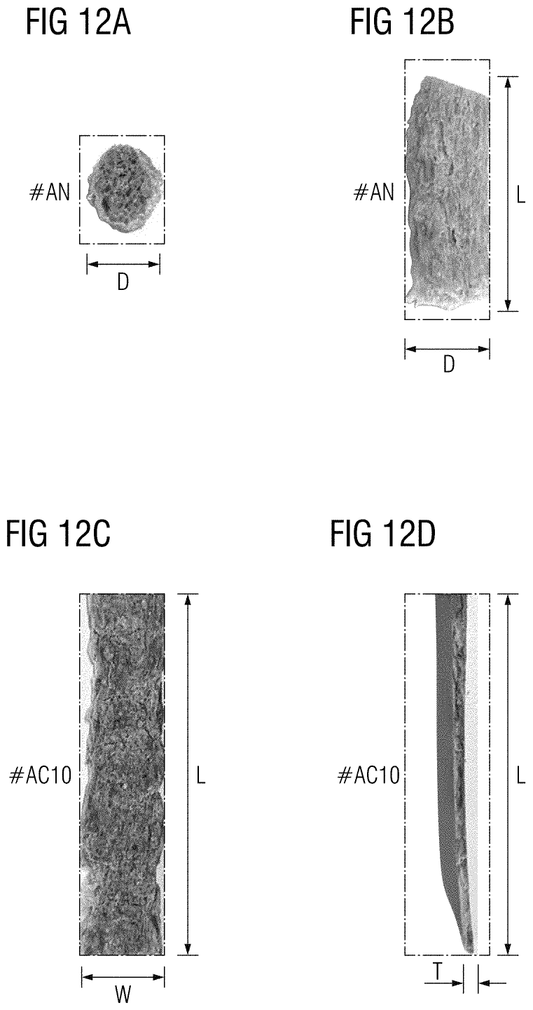

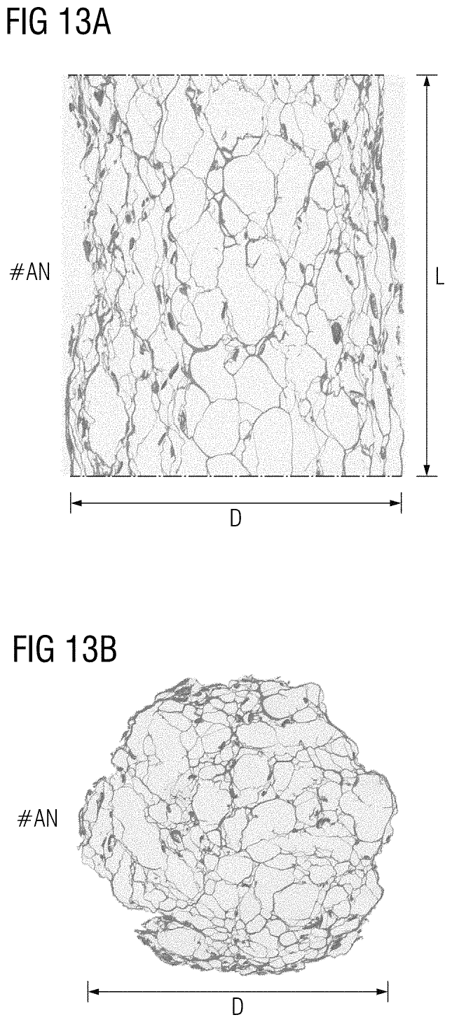

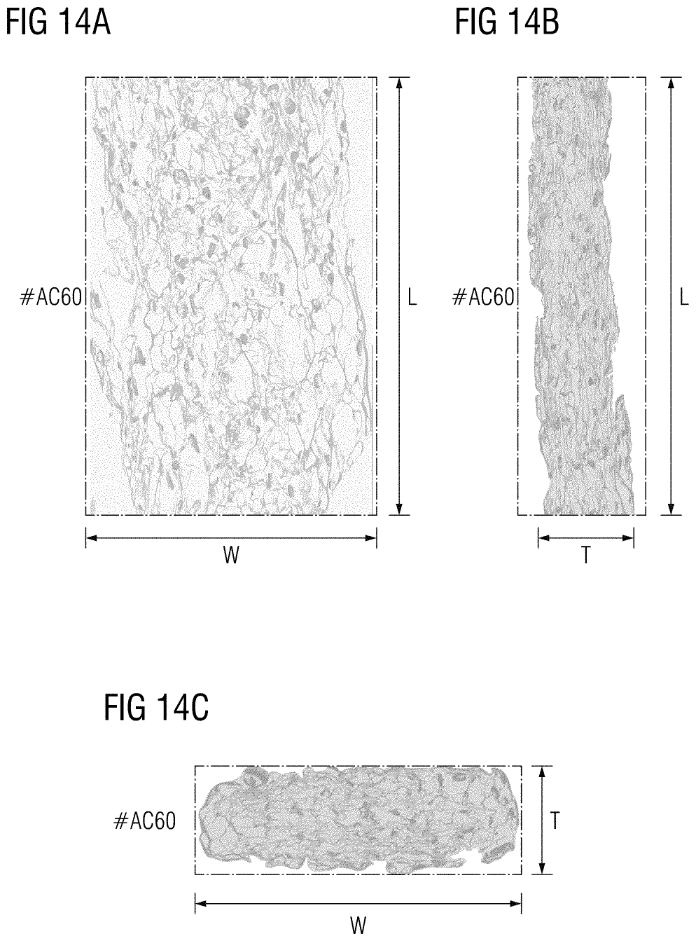

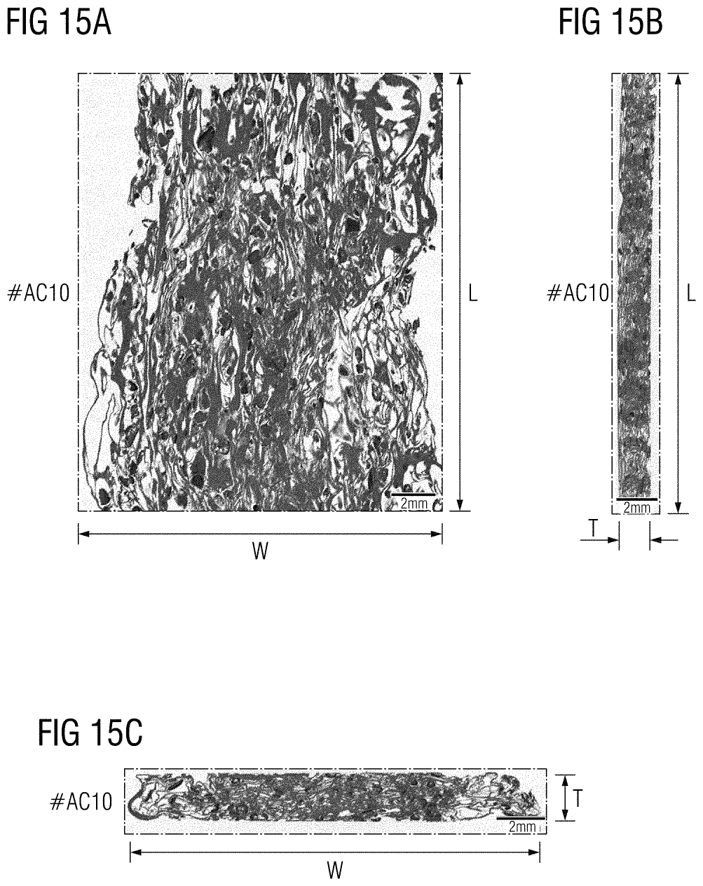

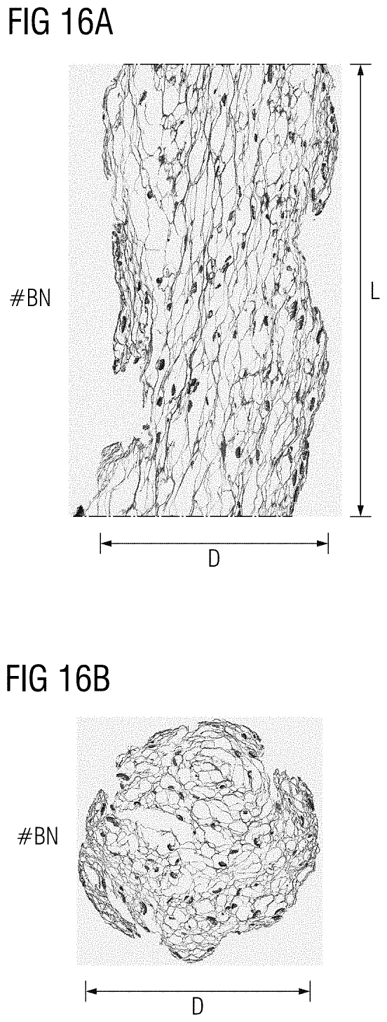

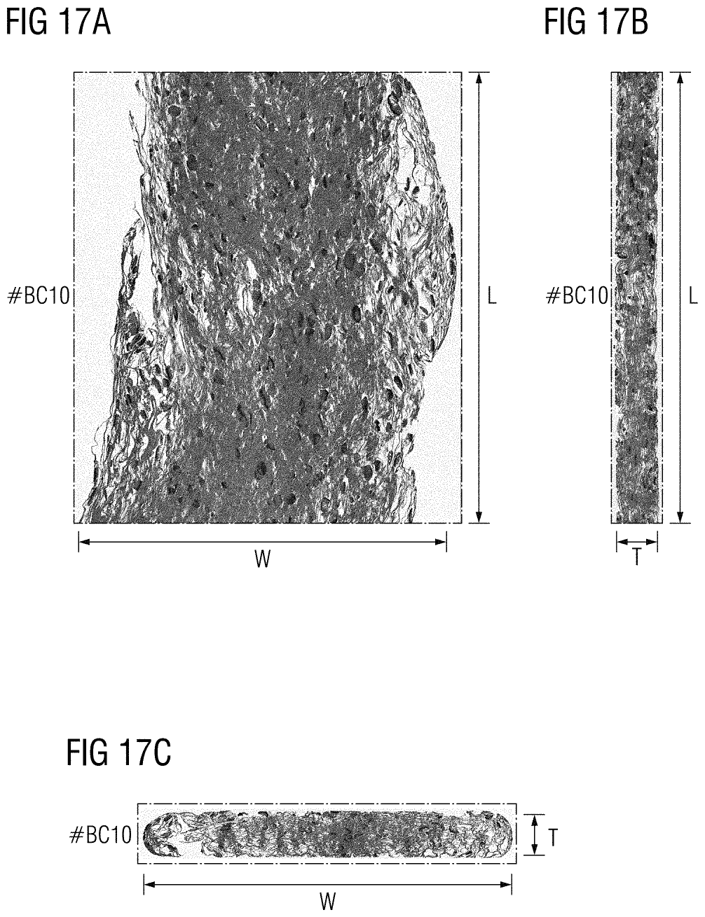

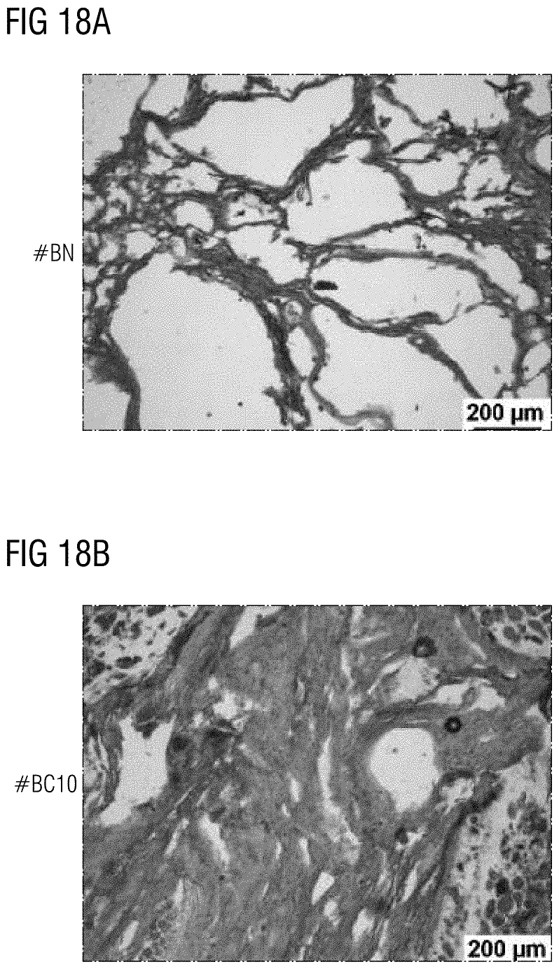

We performed a cooking stability test. The results are shown in FIG. 7.

Extrudate compressed at extremely short post-extrusion time (3 s) kept its thickness (shape) very much more stably than the other compressed extrudate (compressed at later post-extrusion time). This is mainly due to the facts that the extrudate compressed at extremely short post-extrusion time had ultra-high integrity of structure. This is also related to fact that the core of this extrudate is harder to be hydrated by the water. There is a tendency for the compressed extrudate to absorb water and then expand. The extrudates compressed at shorter post-extrusion time had better stability of shape against boiling related expansion.

The extrudate after 2 min water boiling was analysed and observed. The moisture content of the Extrudate Compacted at 3 s after extrusion was significantly lower than the moisture content of the Extrudate without compression, when they were cooked in boiling water for 2 min and centrifuged (removing excessive and loosely bound water) in the same manner. The middle (core) part of the Extrudate Compacted at 3 s after extrusion was clearly dry and dryer than the surface and had the fibrous structure that are firmly bond to each other, after the 2 min cooking. On the other hand, after the same cooking, the extrudate without compression was wet and softer throughout the structure. At the time of writing, more quantitative studies about this are undergoing.

### Experiment 2

### Analysis of the Texture, Compressibility and Stability of the Extrudate (Recipe 1) at Different Post-Extrusion Time

Experiment procedure: Mixing of dry ingredients [symbol] Low moisture extrusion [symbol] textural analyses [symbol] thickness analyses

Step 1: Mixing of dry ingredients: same as in experiment 1. Recipe 1: legume protein flour mix (protein isolate and/or protein concentrate of pea and faba bean, and mixture therefore) 6.5 kg, oat bran 3.5 kg

Step 2: Low moisture extrusion condition: same as in experiment 1.

Step 3: Textural analyses

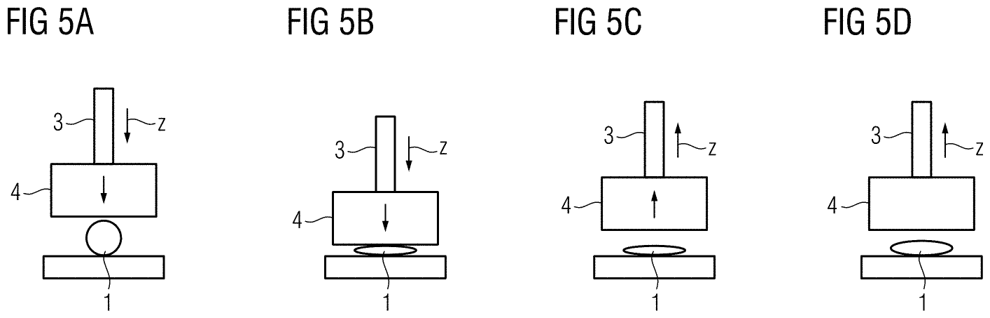

Analysis method 1: Textural (compressibility) analysis of the texturized plant protein extrudate using texture analyser equipped with parallel-plate compression system. FIG. 5A to 5D illustrate the measurement sequence.

Texture analysis settings: test mode: Compression. Testing program: Hold Until Time. Pre-Test Speed: 3 mm/sec, Test Speed 3 mm/sec. Post-Test Speed 10 mm/sec. Target mode: Strain. Compression strain setting: 85% (=compression to 15% of the original sample height). Hold time at the 85% strain position: 20 s. Trigger force 5 g.

Extrudates after extrusion were placed on the platform of texture analyser for testing. The length of the sample was longer than cylinder diameter. Unless specified otherwise, extrudates were rapidly collected and packed in a closed bag to avoid drying, if they were analysed later than 30 sec.

Step 4. Thickness analysis: after the texture analysis is completed, the thickness of the extrudate was analysed at different time points (2 hour and 4 day after the texture analysis). The thickness of the extrudate during texture analysis was recorded by the texture analyser.

FIG. 8 shows the results of texture analysis of the extrudate by parallel-plate compression test, resistance force of extrudate at different post-extrusion time. Compression time was counted since the probe touches the extrudate and then compress at a speed of 3 mm/sec. Measurement time (s) in FIG. 8 refers to the time during the texture analyser analysis and it is counted starting from the point in time the texture analyser probe starts to touch the extrudate.

In FIG. 8 we can see that: the waiting/delaying time between extrusion and compression is positively related to the compression force. The resistance force against compression was first increasing constantly to a peak positive force point, and then kept decreasing during holding period right after the peak positive force point. The peak positive forces of extrudate analysed with different post-extrusion time are summarized in Table 4.

TABLE 4
Texture analysis of the extrudate by parallel-plate compression test,
resistance force of extrudate at different post-extrusion time

| | Peak | | |
|---|---|---|---|
| | Positive | Standard″ | |
| | force (kg) | deviation | n |
| Compressed at 15 s post-extrusion time | 6.4 | 1.6 | 4 |
| Compressed at 70 s post-extrusion time | 14.7 | 2.9 | 3 |
| Compressed at 6 min post-extrusion time | 19.6 | 3.7 | 4 |
| Compressed at 12 min post-extrusion time | 24.0 | 2.0 | 4 |
| Compressed at 32 min post-extrusion time | 24.9 | 1.6 | 3 |
| Compressed at 4 day post-extrusion time | 35.0 | — | 1 |

Table 4 shows that extrudate became harder to be compressed when the post extrusion time was longer. With post extrusion time became longer, the required compression force increased. After 10 to 13 min, the compression force was still increasing along with the post-extrusion time increase, but slower.

In FIG. 8 one sees that the force result curve of all the samples 1, m, n, o, p, q are smooth before and after reaching the peak positive force point. This shows that (a) the change of structure and resistance force were happening gradually, continuously and smoothly, (b) there was no substantial cracking or breaking of internal structure of the extrudates during compression. (c) the extrudates were not brittle or crispy.

FIG. 9 shows the texture analysis results of the extrudate by parallel-plate compression test, comparison between air-dried and moisture preserved extrudate. Compression time was counted since the probe touches the extrudate and then compress at a speed of 3 mm/s. Measurement time (in seconds) in FIG. 9 refers to the time during the texture analyser analysis and it is counted starting from the point in time the texture analyser probe starts to touch the extrudate. Sample q is shown to enable comparing with sample r, in order to illustrate the cracking texture in the curve of r more clearly.

During the texture analysis test, the extrudates under the texture analyser probe had a change of shape from a cylinder shape (approximately 36 mm long and 10.5 mm diameter) to a flat cuboid shape (approximately 36 mm long, 13.6 mm wide and 1.6 mm thick). The contact area between the extrudate and the texture analyser probe was approximately 490 mm² when the maximum compression force was reached.

In FIG. 9 one can see that the texture of the extrudates that were stored 4 days in different conditions: (a) a closed bag that prevents drying; (b) ambient environment (relative humidity 30-60%, temperature 20-25° C.) is different. The extrudate stored in a closed bag kept its original moisture content at approximately 18%, while the extrudate stored in ambient environment was dried and had moisture content of 11% or less. The force result curve of the sample q, extrudate stored in a closed bag, had a shape that the curve was smooth before and after reaching the peak positive force point. This shows that (a) the change of structure and resistance force were happening gradually, continuously and smoothly, (b) there was no substantial cracking or breaking of internal structure of the extrudate during compression. (c) the extrudate was not brittle or crispy. On the other hand, the force result curve of the other sample r, extrudate stored in ambient environment, had a substantially different shape that sharply and frequently increased and decreased before and after the peak positive force point. This is a typical shape of a curve for samples having a crispy texture, and similar to published results about texture of dry and puffed morning cereals, potato chips and cereal crispy biscuits analysed using similar methods. This curve also indicated that the analysed product underwent lots of repeated cracking (breaking) of its structure. In this case, the extrudate has porous structure involving lots of expansion-related cavities distributed in the structure, the wall of each expansion-related cavity is thin and can crack (break) with crispy texture after it is dried. The multiple layers of expansion-related cavities facilitate the repeated breakages and, hence, repeated increase and decrease in the curve.

TABLE 5
Resistance force decrease at holding time after reaching the
peak positive force in texture analysis. Analysed with Analysis
method 1, previously described in Experiment 2 (Textural
analysis of the texturized plant protein extrudate using
texture analyser equipped with parallel-plate compression
system, compression strain 85%, holding time 20 s).

| Texture analysis starting at | | Force decrease | Force decrease |
|---|---|---|---|
| post-extrusion time | | at 0.2 s Holding time | at 1 s Holding time |
| 15 | sec | 31% | 48% |
| 70 | sec | 23% | 39% |
| 6 | min | 19% | 34% |
| 12 | min | 17% | 30% |
| 32 | min | 17% | 29% |
| 4 | days | 12% | 22% |

Table 5 shows that extrudate compressed at short post-extrusion time (for example, less than 70 s) had significantly reduced expansion power (resistance force shown to push up the texture analyser probe) at 1 sec after the extrudate was compressed to the minimum thickness (during the texture analysis). The larger reduction in resistance (expansion) force stands for (a) more internal adhesive force between the materials inside the extrudate; (b) the material has more viscosity property (liquid like) and less elasticity (solid-like).

TABLE 6
Thickness of the extrudates change after 85% strain parallel-plate compression
measurement conducted by a texture analyser

| | Thickness (mm or proportion) of the extrudates | | | | | |
|---|---|---|---|---|---|---|
| | | Minimum | 2 h | 3 days | Expanding | Final |
| | | during | after | after | ratio in 3 day | (3 day) |
| | | com- | com- | com- | after | vs. |
| Samples | Original | pression | pression | pression | compression | original |
| 15 sec post extrusion | 10.5 | 1.6 | 2.9 | 3.1 | 195% | 29% |
| 70 sec post extrusion | 10.5 | 1.6 | 5.5 | 6.3 | 400% | 60% |
| 6 min post extrusion | 10.5 | 1.6 | N.D. | 7.2 | 459% | 69% |
| 12 min post extrusion | 10.5 | 1.6 | 6.5 | 7.0 | 446% | 67% |
| 32 min post extrusion | 10.5 | 1.6 | 6.6 | 7.2 | 457% | 69% |
| No compression | 10.5 | — | — | — | — | 100% |

Table 6 shows that extrudates compressed at shorter post-extrusion time can keep its compressed (reformed) shape (thickness) more stably. Especially, samples compressed at post-extrusion time sec had its thickness expanded for 195% in 3 days of storage (after compression). The post-extrusion time 1.5 min resulted in expansion rate of 400%, while longer post-extrusion time caused even more expansion (around 450%).

### Experiment 3

### Production of the Shock-Compacted Texturized Plant Protein Extrudate Recipe A

Experiment procedure: Mixing of dry ingredients [symbol] Low moisture extrusion [symbol] compression [symbol] packing & evaluation

Step 1: Mixing of dry ingredients (protein with bran and/or flour): Recipe A. Weighing pea protein isolate 6 kg, oat bran 4 kg, thorough mixing.

Step 2: Low moisture extrusion condition: Same as in Experiment 1.

Step 3: Compression: Extrudate coming out from die holes (diameter=5 mm) expanded instantly to diameter of 12-15 mm. Then, samples were collected; 5 s after extrusion, these samples were compressed to 1.6 mm thin using Manual Dough Press Machine (thickness of extrudates after compression is between 9% and 12% of their original thickness). Compression pressure applied on the extrudate was around 86-115 psi.

In order to investigate the effect of post-extrusion time on the compression result, the compression process was contacted at different post-extrusion time (3 s-60 s) with the same compression force.

TABLE 7
Thickness of extrudate after compression using a Manual Dough
Presss Machine, after 1 min and after 2 hour storage

| | Thickness, (mm) | | |
|---|---|---|---|
| Post extrusion | 1 min after | 2 hour after | Expansion |
| time (s) | compression | compression | ratio |
| 3 | 1.60 | 1.61 | 1% |
| 10 | 1.91 | 1.94 | 2% |
| 15 | 1.79 | 1.83 | 2% |
| 16 | 2.04 | 2.04 | 0% |
| 30 | 2.35 | 2.42 | 3% |
| 60 | 2.75 | 2.98 | 9% |

Table 7 shows that extrudates compressed at shorter post-extrusion time can be compressed to a thinner shape, when a same compression force is applied. Extrudates compressed at shorter post-extrusion time also can keep its compressed (reformed) shape (thickness) more stably (expansion ratio, thickness at 2 h storage time compared to thickness at 1 min storage time). Such difference is more significant between extrudates compressed at 30 s and 90 s post-extrusion time, than between 3 s and 30 s. This shows that the post-extrusion time within 30 s is more preferable.

### Experiment 4

### Analysis the Texture, Compressibility and Stability of the Extrudate (Recipe A) at Different Post-Extrusion Time

Experiment procedure: Mixing of dry ingredients [symbol] Low moisture extrusion [symbol] textural analyses [symbol] thickness analyses

Step 1: Mixing of dry ingredients (protein with bran and/or flour): same as in experiment 3. Recipe A. Weighing pea protein isolate 6 kg, oat bran 4 kg, thorough mixing.

Step 2: Low moisture extrusion condition: same as in Experiment 3.

Step 3: Textural analyses: same as in Experiment 2 (Textural analysis of the texturized plant protein extrudate using texture analyser equipped with parallel-plate compression system)

TABLE 8
Texture of extrudate analysed at different post-extrusion
time and storage conditions. Analysed with Analysis method
1, previously described in Experiment 2 (Textural analysis
of the texturized plant protein extrudate using texture
analyser equipped with parallel-plate compression system,
compression strain 85%, holding time 20 s).

| | Peak Positive |
|---|---|
| | Force (kg) |
| Extrudate analysed at 5 s post-extrusion time | 9.8 |
| Extrudate analysed at 30 min post-extrusion | 36.5 |
| (stored in bag) | |
| Extrudate analysed at 30 min post-extrusion | 41.6 |
| (stored in ambient environment) | |
| Extrudate analysed at 4 h post-extrusion | 38.8 |
| (stored in bag) | |
| Extrudate analysed at 4 h post-extrusion | 42.2 |
| (stored in ambient environment) | |

### Experiment 5

### Production of the Shock-Compacted Texturized Plant Protein Extrudate with a Controlled Interval (Hot Steam Treatment) Between Extrusion and Compacting

Flow chart: Mixing of dry ingredients—Low moisture extrusion—Keeping in hot steam environment—shock-compression—packing

Step 1: Mixing of dry ingredients (Recipe A) (protein with bran and/or flour): Recipe A. Weighing pea protein isolate 6 kg, oat bran 4 kg, thorough mixing.

Step 2: Low moisture extrusion Extruder profile: same as in Experiment 1

Step 3: Controlled interval, keeping extrudate in hot steam:

Right after the extrudate come out from extruder (e.g. post-extrusion time less than 30 s, preferably less than 15 s), the extrudates are immediately transferred into a hot steam environment (e.g. 80-100 C) generated by a steamer (a 20 liter stockpot, boiling water, having a sieve above the water, extrudate to be placed on top of the sieve, avoid direct touching between liquid water and the extrudate, a top lid covering the stockpot). The extrudates are kept in the steamer for various time points.

Step 4: Compression: After 10 min of steaming, the extrudates are immediately transferred from the steamer to compressing machine, without substantial time delaying between steaming and compression. The time delay between steaming and compression should be controlled to be less than 60 s, preferably less than 30 s, more preferably less than 15 s. The extrudates are then compressed from original thickness (10 mm) to a thickness of 1.6 mm using a Manual Pizza Dough Presser.

The moisture content of the extrudate was measured, and compared between (a) fresh extrudate; (b) storage in steamer and (c) air dried in ambient environment. Results can be seen in the table below. The moisture content of the extrudate remained mostly unchanged during 10 min steam treatment. This shows that the steam treatment by steamer does NOT substantially hydrate the extrudate but keeps the moisture level similar as its original level.

TABLE 9
Moisture content of the extrudates (fresh, stored
in steamer and stored in ambient environment)

| | Moisture content |
|---|---|
| Extrudate collected right after extrusion | 18.14% |
| (within 3 s post-extrusion) | |
| Extrudate collected right after extrusion | 18.60% |
| (within 3 s post-extrusion), then stored | |
| in a steamer for 10 min | |
| Extrudate collected right after extrusion | 13.32% |
| (within 3 s post-extrusion), then stored in | |
| ambient environment (relative humidity 30-60%, | |
| temperature 20-25° C.) for 4 h | |
| Extrudate collected right after extrusion | 10.8% |
| (within 3 s post-extrusion), then stored in | |
| ambient environment (relative humidity 30-60%, | |
| temperature 20-25° C.) for 4 days | |

### Experiment 6

### Analysis the Texture (Compressibility) of the Extrudate (Recipe B) being Stored in a Steamer after a Short Post-Extrusion Time

Step 1: Mixing of dry ingredients: Recipe B. Pea protein 25%, faba bean protein 25%, oat bran 20%, oat flour 10%, oat protein 20%

Step 2: Low moisture extrusion condition: same as in Experiment 3.

Step 3: Controlled interval, keeping extrudate in hot steam: same as in Experiment 5.

Step 4: Textural analyses: same as in experiment 2 (Textural analysis of the texturized plant protein extrudate using texture analyser equipped with parallel-plate compression system)

FIG. 10 shows the texture of the extrudates: B1 analysed at short post-extrusion time, B2 and B3 with different steaming treatment time (B2: 4 min, B3: 10 min) and then being analysed, and B4: with steaming, chilling and then being analysed. Analysed with Analysis method 1, previously described in Experiment 2 (Textural analysis of the texturized plant protein extrudate using texture analyser equipped with parallel-plate compression system, compression strain 85%, holding time 20 s). More resistance force results after time 10 s were not shown, because they reached plateau earlier.

When post-extrusion time is same and short (5 s), the extrudate treated with different steaming time (4 min and 10 min) both had similar texture (compressibility) as the extrudate without steaming. The extrudates treated by different steaming time difference did not have substantial difference in texture (compressibility).

FIG. 10 shows the surprising findings, after the steam treated extrudate is quickly chilled to room temperature without changing the moisture content, the extrudate loses the compressibility immediately, and turn to be incompatible to produce the highly compressed extrudate. This indicates that prevention of drying alone is not sufficient for maintaining the compressibility of the extrudates.

### Experiment 7

### Analysis the Texture, Compressibility and Stability of the Extrudate (Recipe A) being Stored in a Steamer after a Short Post-Extrusion Time

Step 1: Mixing of dry ingredients: same as in experiment 3. Recipe 2. Weighing pea protein isolate 6 kg, oat bran 4 kg, thorough mixing.

Step 2: Low moisture extrusion condition: same as in experiment 3.

Step 3: Controlled interval, keeping extrudate in hot steam: same as in experiment 5.

TABLE 10
Texture of extrudates analysed after different post-extrusion treatment
or storage. Analysed with Analysis method 1, previously described
in Experiment 2 (Textural analysis of the texturized plant protein
extrudate using texture analyser equipped with parallel-plate compression
system, compression strain 85%, holding time 20 s). The average peak
positive force is computed from a series of three measurements. In
FIG. 11 only one typical measurement result is shown.

| | Average Peak |
|---|---|
| | Positive Force (kg) |
| Extrudate analysed at 5 s post-extrusion time | 9.8 |
| (cf. A1 in FIG. 11) | |
| Extrudate analysed after 5 s post-extrusion time | 13.7 |
| and 10 min storage in steamer (cf. A2 in FIG. 11) | |
| Extrudate analysed at 4 h post-extrusion time | 38.8 |
| (stored in bag) | |
| Extrudate analysed after 5 s post-extrusion time, | 37.4 |
| 10 min storage in steamer and 4 h post-steaming | |
| storage in bag (cf. A3 in FIG. 11) | |

Table 10 shows that the change of extrusion recipe (recipe in Experiment 6 was different from the recipe in Experiment 5) did not change the trend of the effects of steaming on extrudate texture. When post-extrusion time is same and short (5 s), the extrudate treated with steaming (10 min) had similar texture (compressibility) as the extrudate without steaming. The extrudate stored in a bag for 4 h without being steaming treated during storage had very much harder texture (poorer compressibility) than the extrudate at 5 s post-extrusion time, and the extrudate had steaming treatment after 5 s post-extrusion time. Moreover, post-steaming time was similarly adversely affecting the texture (compressibility) as how the post-extrusion time does. The texture after 4 h storage was similar for the extrudate with and without steaming treatment.

FIG. 11 shows the measurement results for texture of extrudates with and without post-extrusion treatments. Analysed with Analysis method 1, previously described in Experiment 2 (Textural analysis of the texturized plant protein extrudate using texture analyser equipped with parallel-plate compression system, compression strain 85%, holding time 20 s). More resistance force results after time 10 s were not shown, because they reached plateau earlier.

FIG. 11 shows the measurement results which are also listed in Table 11. The results show that the change of extrusion recipe (recipe in Experiment 6 was different from the recipe in Experiment 5) did not change the trend of the effects of steaming on extrudate texture. When post-extrusion time is same and short (5 s), the extrudate (A2 in FIG. 11) treated with steaming (10 min) had similar texture (compressibility) as the extrudate without steaming (A1 in FIG. 11). However, when there was a layer of plastic bag preventing the direct contact between the steam (elevated humidity) and the extrudate, the extrudate got much harder (higher compression resistance force, less compressibility) in 10 min of storage time (A3 in FIG. 11). It should be noted that the temperature of storing the extrudates (during the 10 min storage) was similar for the extrudates in the steamer with and without the plastic bag packing (insulating).

This reveals a surprising finding that, when the steaming environment is replaced with a heating and closed environment without elevated humidity, the extrudate loses the compressibility quickly, and turn to be incompatible to produce the highly compressed extrudate. The elevated humidity can better preserve the moisture content level of the extrudate than the closed environment does, though the elevated humidity should not increase the moisture content of the extrudate. The reason for this special requirement of the elevated humidity can be related to the high temperature or heating history of the extrudate that make the extrudates dry fast or have fast water mobility within the extrudate structure.

TABLE 11
Thickness and stability of the extrudate after the texture analysis.
The texture analysis compressed the extrudate using a texture
analyser equipped with parallel-plate to 15% of its original
thickness and then held at that position for 20 s.

| | Thickness (mm) | | | |
|---|---|---|---|---|
| | | Minimum | After | After |
| | Before | during | 2 h | 3 d |
| | compression | compression | storage | storage |
| Extrudate compressed at | 11.3 | 1.7 | 2.7 | 2.8 |
| 3 s post-extrusion time | | | | |
| Extrudate compressed at | 11.3 | 1.7 | 3.1 | 3.1 |
| 30 s post-extrusion time | | | | |
| Extrudate compressed at | 11.3 | 1.7 | N.D. | 6.4 |
| 4 h post-extrusion time | | | | |
| Extrudate collected right | 11.3 | 1.7 | 2.9 | 3.5 |
| after extrusion (within | | | | |
| 3 s post-extrusion), | | | | |
| then stored in a steamer | | | | |
| for 10 min | | | | |

When post-extrusion time is same and short (3 s), the extrudate treated with steaming (10 min) had similar compressibility and stability of keeping the compressed (reformed) shape (thickness) as the extrudate without steaming (close to extrudate compressed at 3 s post-extrusion time; and even closer to extrudate compressed at 30 s post-extrusion time). In contract, the extrudate being compressed at 4 h post-extrusion time and stored without steaming had clearly more expansion of the thickness after 3 day post-compression storage.

### Experiment 8

### Cooked Ready-to-Eat Meat-Analogue-Containing Food Made with the Shock-Compacted Extrudate

Flow chart: Mixing of dry ingredients—Low moisture extrusion—shock compression—mixing with sauce—packing in cooking bag—autoclave cooking (115° C., 10 min)—chilling

Three types of extrudates having the same ingredients (same raw material composition, recipe 1, Legume protein flour mix (a mixture of protein isolate and protein concentrate of pea and faba bean) 65%, and oat bran 35%.) were selected:

TABLE 12
Samples used

| Code | Name | Make | Representing |
|---|---|---|---|
| Sample 1 | Semi-dense | Extrudate produced by low | Represents extrudates that |
| | extrudate | moisture extrusion, with | have the highest density |
| | produced at semi- | extrusion moisture content | achievable with the |
| | high moisture | close to the higher limit of low | conventional low-moisture |
| | level | moisture extrusion, moisture | extrusion production, and |
| | | content of the extruded | often have less spongy |
| | | material (a sum of moisture | mouthfeel than the |
| | | from the powder ingredients | extrudates produced at |
| | | and moisture from the liquid | extrusion moisture content |
| | | feeder) during extrusion was | below 27%. |
| | | 27-34%, preferably close to | |
| | | 28.5% | |
| Sample 2 | Extrudate without | Extrudate produced by low | Represents the most typical |
| | compression | moisture extrusion, with | low moisture extruded |
| | | extrusion moisture content 20- | product, which is spongy and |
| | | 27%, preferably close to 24% | easy to absorb water during |
| | | | soaking (being immersed) |
| | | | and cooking in water |
| Sample 3 | Extrudate | Extrudate produced by low | Represents the newly |
| | compressed at 3 s | moisture extrusion, with | invented products in this |
| | post-extrusion | extrusion moisture content 20- | application |
| | time | 27%, preferably close to 24% | |

Cooking and Sensory Evaluation:

Weight the extrudate samples (20 g), add sauce (95 g, Uncle Ben's Medium Curry sauce) and mix evenly. Then put the mixture into cooking bags, sealed with 90% vacuum. Cooking the bags of products in autoclave with 115° C. and 10 min sterilizing time cooking program. Take them out when program ended and put in cold room for cooling and storing for overnight. Then take the marinated and cooked products out, put on top of plate, heat up with microwave 750 W, 2 min 30 s. These samples were analysed by expert panellist sensorial evaluation.

Sauce: Uncle Ben's® (Uncle Ben's is a trademark of MARS Incorporated) Medium Curry sauce (Ingredients: water, tomatoes, onions (12%), red peppers (6%), cornflour, sugar, coconut (2.8%), lemon juice, roasted onion paste (2%) (onions, sunflower oil, salt), sunflower oil, spices, salt, curry powder (0.8%) (contains celery, mustard), ginger, garlic)

TABLE 13
Sensorial evaluation result:

| Sample | Mouthfeel |
|---|---|
| Sample 1, Semi-dense | Bad (Mushy, all the way soft, |
| extrudate produced at | obviously dissolving in the sauce) |
| semi-high moisture level. * | |
| Sample 2, Extrudate | Bad (Spongy, soft at the beginning of |
| without compression | chewing, semi-elastic and rubbery at |
| | the end of chewing, having sauce inside |
| | the extrudate that gave unfamiliar |
| | unfavourable eating experience) |
| Sample 3, Extrudate | Preferably, acceptable as a good product |
| compressed at 3 s | for curry marinated meat food analogue, |
| post-extrusion time | chewy, having meat-like texture |
| (experiment 1) | |

### About Certain Definitions

In the description, we try to characterize some embodiments of the compacting/compressing that is utilized in carrying out the method with using the term “compressive rheology pressing method”.

In the literature, R. G. de Kretser, D. V. Boger and P. J. Scales, Rheology Reviews 2003, pp 125-165. COMPRESSIVE RHEOLOGY: AN OVERVIEW defines that “compressive rheology broadly refers to the study and measurement of the de-watering/consolidation behaviour of solid-liquid systems ranging from dilute up to fully networked solids concentrations”. Further, they write: “Contrary to yielding in shear, the field of compressive rheology is concerned with the subsequent expulsion of fluid from the network after yielding, leading to an increase in the concentration of the particle network via consolidation and de-watering.”

We are using the expression “compressive rheology pressing method” in an adapted sense. “Compressive rheology pressing method” as we see it could alternatively be defined using the words of the article of Kretser, Boger and Scales “The main criteria that must be satisfied for measurement of compressive rheology is that a sufficient particle concentration must exist in the system such that inter-particle interactions within the system cause a continuous network to form and this network is subject to uniaxial compression.”

Therefore, our definition of the “compressive rheology pressing method” requires a modification to:
“contrary to yielding in shear, the compressive rheology in this context means compression intended to the subsequent expulsion of fluid/air from the network after yielding, leading to an increase in the concentration/density and an increase in inter-particle/inter-fibre interactions of the particle/fibre/solid network via consolidation and de-watering/degassing”

### Addendum

Since the priority filing, the inventors have continued their work on the invention.

### Experiment 9

### Experiment procedure

Mixing of dry ingredients [symbol] Low moisture extrusion [symbol] compression [symbol] packing & evaluation

Step 1: Mixing two types of dry ingredients (protein with bran and/or flour): Recipe A. Weighing pea protein isolate 6 kg, oat bran 4 kg, thorough mixing. (as originally disclosed in Experiment 3); and Recipe B. Pea protein 25%, faba bean protein 25%, oat bran 20%, oat flour 10%, oat protein 20% (as originally disclosed in Experiment 6).

Step 2: Low moisture extrusion condition: Same as in Experiment 1.

Step 3: Compression: Similar as in Experiment 3. Extrudate coming out from die holes (diameter=5 mm) expanded instantly to diameter of 10-15 mm.

Then, samples were collected. Then at different post-extrusion time, these samples were compressed to 1.6 mm thin using Manual Dough Press Machine (thickness of extrudates after compression is between 9% and 12% of their original thickness). Compression pressure applied on the extrudate was around 86-115 psi (5.93 bar to 7.93 bar). In order to investigate the effect of post-extrusion time on the compression result, the compression process was contacted at different post-extrusion time 10 s and 60 s with the same compression force. Extrudate sample without compression was also taken for comparison.

The samples produced from this experiment are listed in Table 14.

TABLE 14
Samples in Experiment 9

| | | | | Illustration/ |
|---|---|---|---|---|
| Name | Experiment | Recipe | Compression | Microstructure |
| #AN | Experiment 9 | Recipe A | No compression | FIG. 12A, |
| | | | | FIG. 12B |
| | | | | FIG. 13A, |
| | | | | FIG. 13B |
| #AC60 | Experiment 9 | Recipe A | Compressed at | FIG. 14A, |
| | | | 60 s post- | FIG. 14B, |
| | | | extrusion time | FIG. 14C |
| #AC10 | Experiment 9 | Recipe A | Compressed at | FIG. 12C, |
| | | | 10 s post- | FIG. 12D |
| | | | extrusion time | FIG. 15A, |
| | | | | FIG. 15B, |
| | | | | FIG. 15C |
| #BN | Experiment 9 | Recipe B | No compression | FIG. 16A, |
| | | | | FIG. 16B, |
| | | | | FIG. 18A |
| #BC10 | Experiment 9 | Recipe B | Compressed at | FIG. 17A, |
| | | | 10 s post- | 17B, 17C, |
| | | | extrusion time | FIG. 18B |

The samples were analyzed using X-ray microtomography (Micro-CT) scanning and light microscope.

The method of using the X-ray microtomography (Micro-CT) scanning for characterizing microstructure of extruded starch breakfast cereals was available for people skilled in the art, for example, reference can be taken from J. M. R. Diaz et al.

The settings used in the X-ray microtomography (Micro-CT) scanning were that each pixel in the scanned image represents a material length of 0.01 mm. Samples were rotated by a total of 180° during the scanning process with a pixel size of 10 μm (0.01 mm) to obtain an optimum resolution.

The Micro-CT scanning results shown in FIG. 13A, 13B; FIG. 14A, 14B, 14C; FIG. 15A, 15B, 15C; FIG. 16A, 16B; FIG. 17A, 17B, 17C were made with re-slicing technique by using an open source software Fiji which is an image processing package. The pictures shown in these FIG were selected as representative illustrations and were planes (layers) that were scanned near the middle of the scanned product (i.e. not on the surface of the scanned product). The darker shades in these FIG indicate solid material (i.e. proteinaceous material. The lighter shades indicate air bubbles.

In Experiment 9 and in FIG. 12A, 12B, 12C, 12D; FIG. 13A, 13B; FIG. 14A, 14B, 14C; FIG. 15A, 15B, 15C; FIG. 16A, 16B; FIG. 17A, 17B, 17C; and FIG. 18A, 18B, the three dimensions of the product were described as “length” (B), “thickness” (T) and “width” (W) dimensions.
The length dimension refers to the dimension along with (in parallel with) the direction that the extruded material moving out from the extruder die);
the thickness dimension refers to the shortest dimension of the products, which was perpendicular to the compression direction (for compressed samples) or were the same as the diameter of the sample (perpendicular to the length dimension, for non-compressed samples);
the width dimension was perpendicular to the length and, at the same time, perpendicular to the thickness dimension-a.

As shown by comparing FIG. 12B and FIG. 12D, the extrudate is clearly thinner after being compressed.

The X-ray microtomography (Micro-CT) scanning image were quantitatively analyzed with Fiji analysis software. We used the Fiji analysis software (version ImageJ 1.52i, downloaded between 1 and 11 Jun. 2021, Wayne Rasband, National Institutes of Health, USA, http://imagej.nih.gov/ij. Java 1.8.0_172 (64-bit). ImageJ is in the public domain).

The length and width of air bubbles in FIG. 13A, FIG. 14B, FIG. 15B, FIG. 16A, were measured, with at least 15 measurement points of each sample. (“View containing Thickness×Length”). Minimum-, average-, and maximum values were calculated. The measurements were conducted with length measurement function of the Fiji analysis software. The results are shown in Table 15.

TABLE 15
Length and width of air bubbles in the extrudate observed by X-ray
microtomography (Micro-CT) scanning

| | #AN | | #AC60 | | #AC10 | | #BN | | #BC10 | |
|---|---|---|---|---|---|---|---|---|---|---|
| | Length | Width | Length | Width | Length | Width | Length | Width | Length | Width |
| | (mm) | (mm) | (mm) | (mm) | (mm) | (mm) | (mm) | (mm) | (mm) | (mm) |
| Minimum | 1.08 | 0.39 | 0.41 | 0.07 | 0.39 | 0.02 | 1.38 | 0.15 | 0.16 | 0.03 |
| Average | 2.98 | 1.05 | 1.76 | 0.17 | 0.81 | 0.07 | 2.78 | 0.56 | 0.46 | 0.05 |
| Maximum | 5.14 | 2.10 | 3.37 | 0.28 | 1.70 | 0.14 | 4.35 | 0.90 | 0.72 | 0.06 |

The ratio between the width and length of each air bubble in FIG. 13A, FIG. 14B, FIG. 15B, FIG. 16A was calculated. (“View containing Thickness×Length”). The measurements were conducted with particle analysis function of Fiji analysis software. The results are shown in Table 16.

TABLE 16
The ratio between the width and length of each air bubble

| | #AN | #AC60 | #AC10 | #BN | #BC10 |
|---|---|---|---|---|---|
| average | 39% | 12% | 11% | 22% | 11% |
| range of the majority | 20-64% | 4-20% | 3-18% | 15-31% | 8-13% |

As can be seen in FIG. 13A, 14B, 15B, 16A and in Table 15 and Table 16, the air bubbles in the compressed extrudate clearly have a smaller length and width than the air bubbles in the non-compressed extrudate. The air bubbles in the compressed extrudate have a clearly more elongated-like or stretched-like or narrowed shape, meaning that the ratio between width and length of each air bubble has been significantly decreased from approximately 22-39% (average value, #PAN and #BN, no compression) to 12% (#AC60), and further to 11% (#AC10 and #BC10, compression at shorter post-extrusion time). The results show that we have manufactured an extrudate produced with low moisture extrusion which was compressed after extruding, which comprises air bubbles that mainly have width less than 0.5 mm, preferably less than 0.2 mm, more preferably less than 0.1 mm. Alternatively to this or in addition, the extrudate can be characterized as having air bubbles that mainly have width-to-length ratio smaller than 22%, preferably smaller than 15%.

The size distribution of the extrusion-related cavities (air bubbles) in FIG. 13A, 14B, 15B, 16 A was measured. (“View containing Thickness×Length”). The size of each air bubble was represented in the area of each air bubble being scanned in the image. The values of each product were calculated by dividing the sum of the area of all the air bubbles having size within the range (listed in the first column) by the sum of area of all the air bubbles in the sample. The measurements were conducted with particle analysis function of Fiji analysis software. The results are shown in Table 17.

TABLE 17
The size distribution of the air bubbles observed
by X-ray microtomography (Micro-CT) scanning

| size (area) | #AN | #AC60 | #AC10 | #BN | #BC10 |
|---|---|---|---|---|---|
| >1 mm² | 84% | 0% | 0% | 48% | 0% |
| between 0.3 and 1 mm² | 10% | 24% | 0% | 22% | 15% |
| between 0.03 and 0.3 mm² | 5% | 54% | 4% | 25% | 19% |
| between 0.01 and 0.03 mm² | 1% | 12% | 35% | 3% | 24% |
| <0.01 mm² | 0% | 10% | 61% | 2% | 41% |

As can be seen in Table 17, when the view of thickness and length was observed, the non-compressed extrudate had much larger air bubbles than the compressed extrudate, and the compression at a shorter post-extrusion time made further smaller size air bubbles. The air bubbles in non-compressed extrudate (#PAN and #BN) were substantially (48-84%) larger than 1 mm²; mostly (70-94%) larger than 0.3 mm²; rarely (1-5%) smaller than 0.03 mm². On the other hand, the extrudate had, after the irreversible reduction of the air bubbles due to compression, significant (considerable) proportion (22-96%) of air bubbles being smaller than 0.03 mm². Furthermore, as preferable samples, #AC10 and #BC10, the extrudates beings compressed at short post-extrusion time (10 s), had substantial proportion (41-61%) of air bubbles being smaller than 0.01 mm²; and major proportion (65-96%) of air bubbles being smaller than 0.03 mm².

As additional information not shown in Table 17, when the samples were analyzed in view toward the thickness×length of the samples, the sample #AN had 84% (among the total area of all the bubbles) of its air bubbles being larger than 1 mm² (area-represented particle size), and 73% of its air bubbles being larger than 2 mm²; sample #AC60 had 41% of its air bubbles being larger than 1 mm² and 29% of its air bubbles being larger than 2 mm²; sample #AC10 had less than 10% of its air bubbles being larger than 1 mm² and less than 1% of its air bubbles being larger than 2 mm². Sample #BN had 48% of its air bubbles being larger than 1 mm² and 21% of its air bubbles being larger than 2 mm². Sample #BC10 had less than 1% of its air bubbles being larger than 1 mm².

The solid fraction of unit regions (unit blocks, having size of 0.5 mm along with the width dimension of the extrudate and 1 mm along with the length dimension) in FIG. 13A, 14A, 15A, 16A, 17A was measured. (“View containing Width×Length”). Solid fraction of a unit region refers to the proportion of area of the solid materials (i.e. proteinaceous materials) among the total area of the unit region. This is value that can be calculated by the Fiji software with “% Area” values. Solid fraction was a term commonly used in studies concerning pharmaceuticals tablets and alike. Solid fraction was sometimes understood as similar to relative density. Solid fraction in some published studies were calculated as “solid fraction=1—porosity”, which showed that solid fraction was opposite to porosity and “product with higher solid fraction is less porous”. There were at least 30 different unit regions being appointed (manually selected, in purpose of analysis with fragmentation) within the sample in each analyzed FIG. The solid fraction of each unit region was calculated. The population was calculated by dividing the count of the unit regions having certain solid fraction value range by the total amount of unit regions being analyzed in the analyzed FIG. The results are shown in Table 18.

TABLE 18
The solid fraction of unit regions

| Solid fraction | Population among all the analyzed unit regions | | | | |
|---|---|---|---|---|---|
| value range | #AN | #AC60 | #AC10 | #BN | #BC10 |
| between 90 and 100% | 0% | 0% | 0% | 0% | 55% |
| between 70 and 90% | 0% | 4% | 25% | 0% | 39% |
| between 50 and 70% | 0% | 21% | 28% | 2% | 6% |
| between 40 and 50% | 2% | 24% | 16% | 23% | 0% |
| between 20 and 40% | 35% | 42% | 23% | 53% | 0% |
| <20% | 63% | 9% | 8% | 22% | 0% |

As can be seen in Table 18, the non-compressed extrudates (samples #PAN and #BN) were clearly more porous and had most of the unit regions (74-98%) being porous (having solid fraction value smaller than 40%). The non-compressed extrudates (samples #AN and #BN) did not have any unit region having solid fraction value being no less than 70%. The compressed extrudates (samples #AC60, #AC10 and #BC10) had clearly more unit regions (4-94%) that had high solid fraction values (no less than 70%). The further preferred samples (samples #AC10 and #BC10) being compressed at short post-extrusion time (10 s) had further higher population of unit regions (25-94%) that had high solid fraction values (no less than 70%). The high solidity (high population of unit regions with high solid fraction value, high relative density) and low porosity (“porosity” can be calculated as the value of “1—solid fraction value”) of the compressed extrudate contribute to improvement in their mouthfeel (less sponge-like texture and mouthfeel, firmer biting chewiness, higher structural integrity, and better cooking resistance).

Additionally, as in agreement with the results shown in corresponding FIG of X-ray microtomography (Micro-CT) scanning images, the structures of compressed extrudates (#AC60, #AC10 and #BC10) were not homogenous. Some of the regions (area, zone) of the sample had clearly higher solid fraction (more dense, more crowded, having wider fibers), while some of the other regions of the sample had clearly lower solid fraction (more dense, having more visible individual narrower fibers). The compressed extrudates (#AC60, #AC10 and #BC10) had certain population (no less than 4%, preferably no less than 20%) of unit regions having high solid fraction value (no less than 70%), and at the same time had certain population (no less than 6%) of unit regions having solid fraction value below 70%. This uneven, non-homogeneous structure contribute to the favorable mouthfeel of the extrudate by, for example, making it richer and diverse.

The fiber width (also can be understood as fiber thickness, fiber broadness) of the proteinaceous fibers (fibrous shaped solid materials) in FIGS. 13A and 15A was measured. (“View containing Width×Length”). The measurements were conducted with length measurement function of Fiji analysis software. The results are shown in Table 19.

TABLE 19
The fiber width

| | #AN | #AC10 |
|---|---|---|
| Minimum fiber width | 0.03 mm | 0.02 mm |
| Average fiber width | 0.09 mm | 0.32 mm |
| Maximum fiber width | 0.27 mm | 1.59 mm |

As can be seen in Table 19, the compressed extrudate (#AC10) had clearly wider (thicker bunch, broader) fibers in its fibrous structure than the non-compressed extrudate (#PAN). For example, the average fiber width of compressed extrudate (#AC10) was nearly 3 times as that of the non-compressed extrudate (#PAN). Substantial amount of the fibers in compressed extrudate (#AC10) had width between 0.32 and 1.59 mm, while the maximum fiber width of the non-compressed extrudate (#PAN) was 0.27 mm. The wider (thicker, broader) fibers of the extrudate structure contribute to improvement in their mouthfeel (firmer biting chewiness, higher structural integrity, and better cooking resistance).

The overall solid fraction values of the whole scanned structure (i.e. within the sample structure, excluding the surface or edge regions of the sample, covering approximately 90% of the sample area) was estimated with Fiji analysis software for each of the samples. The results are shown in Table 20.

TABLE 20
The overall solid fraction values

| | Overall solid fraction value | | | | |
|---|---|---|---|---|---|
| | #AN | #AC60 | #AC10 | #BN | #BC10 |
| View toward | 11% | 35% | 58% | 25% | 93% |
| width × length | | | | | |
| View toward | 11% | 45% | 83% | 25% | 90% |
| thickness × length | | | | | |

As additional information not shown in Table 20, when observed in view toward thickness×length of the samples, sample #AC10 had a small amount of regions (population between 5 and 30%) having low solid fraction value (less than 75%), and at the same time had a small amount of regions (population between 5 and 30%) having high solid fraction value (higher than 95%). On the other hand, as shown in Table 18, the overall solid fraction value in the same view direction was 83%. This uneven, non-homogeneous structure contributes to the favorable mouthfeel of the extrudate by, for example, making it richer and diverse, and more natural.

The results in Table 20 also reveal that the compressed extrudate (#AC60, #AC10 and #BC10) have a strongly reduced (“porosity value=1—solid fraction value”), advantageously 65% or lower, preferably 42% or lower (#AC10 and #BC10), when analyzed by the X-ray microtomography (Micro-CT) scanning method. On the other hand, the non-compressed extrudates (#AN and #BN) had a much higher porosity (75%-89%).

As shown by comparing FIG. 18A with FIG. 18B, the compressed extrudate (sample #BC10) had its neighboring fibers in fibrous structure attached and laminated between each other, and resulted in fiber bunch as wide as 0.5 mm, which is much wider than the separated and narrow fibers in extrudate (sample #BN, mostly narrower than 0.1 mm). The samples in these FIG were hydrated before analysis. So the laminated and broadened fiber bunches are stable and do not separate into individual narrow fibers after the being treated by hydration.

### Experiment 10

### Experiment Procedure

Mixing of dry ingredients [symbol] Low moisture extrusion [symbol] compression [symbol] adjusting moisture content [symbol] packing & evaluation

Step 1: Mixing two types of dry ingredients (protein with bran and/or flour): Recipe 1. (Same as in Example 1) Legume protein flour mix (a mixture of protein isolate and protein concentrate of pea and faba bean) 65%, and oat bran 35%. Recipe C. Legume protein flour mix (a mixture of protein isolate and protein concentrate of pea and faba bean) 40%, oat bran 20%, and oat flour 40%. Thorough mixing.

Step 2: Low moisture extrusion condition: Same as in Experiment 1.

Step 3: Compression: Similar as in Experiment 3. Extrudate coming out from die holes (diameter=5 mm) expanded instantly to diameter of 10-15 mm.

Then, samples were collected. Then at different post-extrusion time, these samples were compressed to 1.6 mm thin using Manual Dough Press Machine (thickness of extrudates after compression is between 9% and 12% of their original thickness). Compression pressure applied on the extrudate was around 86-115 psi (5.93 bar to 7.93 bar) at post-extrusion time 10 s. Extrudate sample without compression was also taken for comparison. The extrudate length can be controlled by cutting, which can be conducted before the compression or after the compression.

The samples (from Recipe 1. and from Recipe C.) had thickness approximately 1.6-2.0 mm, width approximately 10 mm and length approximately 40 mm.

The samples (from Recipe 1. and from Recipe C.) had moisture content between 7% and 11%, and water activity (Aw) between 0.20 and 0.64. The moisture content and water activity can be optionally regulated by drying in dry air or with a dryer machine.

The samples can be optionally further flavored, such as by coating them with sprinkled salt, spices, fruit powder, sugar, syrup and oil.

When the samples (from Recipe 1. and from Recipe C.) were eaten as dry products, they had texture (mouthfeel) that can be regarded as favorable and novel crispy snacks. More specifically, such texture (mouthfeel) had different features (unique characteristic) during different eating stages, such as: (stage 1), during initial biting and cracking in mouth, the mouthfeel was substantially perceived as brittle, hard, firm, dense and crispy in good manner (in pleasant ways). And the mouthfeel during this stage was mostly NOT fluffy, porous, fragile, sponge-like, rubbery or gummy. And the crispiness during this stage had certain similarity to potato chips, thin waffle, and dried thin rye crisps (hard foods that emit a sound upon fracturing); (stage 2), during the continued chewing and mixing with saliva in mouth, the mouthfeel was substantially perceived as like chewing muscle-like fibers or fiber-bunches, chewy, non-homogenous, rich and natural. And the mouth feel in this stage was mostly NOT porous, sponge-like, doughy (dough-like, bread-like), clayish, sandy, or liking morning-cereals. And the mouthfeel during this stage had similarity to (can remind of) dried meat such as beef jerky or dried pork.

The inventors found that the products were crispy in a way that they are brittle but not porous, which can be described with Crushing Force, Crispiness Work, Amount of Peaks, Crispiness Index using methods such as according to the published study of S.A. Alam et al.

The products had
a. moderate-high or high Crushing Force measured by textural analyzer compression test (such as),
b. and high Crispiness Work measured by textural analyzer compression test,
c. small amount of peaks appearing on the Force-Distance Curve (F-d curve), in the textural analyzer compression test, and
d. moderate or low Crispiness Index measured by textural analyzer compression test.

The inventors were unable to finalize exact analysis results prior to submitting this international application. We would be submitting the results as evidence after they are finalized.

Extrudate samples without compression were also evaluated for comparison. When extrudate samples without compression were eaten as dry products, their texture (mouthfeel) was different. More specifically, during initial biting and cracking in mouth, the mouthfeel of such sample was substantially perceived as fluffy, porous, fragile-surface and sponge-like.

### Final Words

It is obvious to the skilled person that, along with the technical progress, the basic idea of the invention can be implemented in many ways. The invention and its embodiments are thus not limited to the examples and samples described above but they may vary within the contents of patent claims and their legal equivalents.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated feature but not to preclude the presence or addition of further features in various embodiments of the invention.

### LIST OF REFERENCES CITED

Handbook of food proteins, edited by G. O. Phillips and P. A. Williams. 2011. Woodhead Publishing Series in Food Science, Technology and Nutrition: Number 222. Published by Woodhead Publishing Limited, Chapter 15, Texturized vegetable proteins by M. N. Riaz
Trinh, Khanh Tuoc and Steve Glasgow. Conference Paper. Conference: Chemeca 2012, At Wellington, New Zealand
R. G. de Kretser, D. V. Boger and P. J. Scales, Rheology Reviews 2003, pp 125-165. COMPRESSIVE RHEOLOGY: AN OVERVIEW
Diaz, J. M. R., Suuronen, J. P., Deegan, K. C., Serimaa, R., Tuorila, H., & Jouppila, K. (2015). Physical and sensory characteristics of corn-based extruded snacks containing amaranth, quinoa and kañiwa flour. LWT-Food Science and Technology, 64(2), 1047-1056.
Alam, S. A., Jarvinen, J., Kirjoranta, S., Jouppila, K., Poutanen, K., & Sozer, N. (2014). Influence of particle size reduction on structural and mechanical properties of extruded rye bran. Food and Bioprocess Technology, 7(7), 2121-2133

1.-55. (canceled)

56. A method for improving the proteinaceous fibre structure of a textured vegetable protein product, comprising:
preparing an extrudate with an extruder configured to carry out low-moisture protein texturization extrusion, the extrudate comprising a proteinaceous fibre structure having expansion-related cavities, such as air bubbles, between the proteinaceous fibres;
after the extrusion, one of compressing or compacting the extrudate in a manner leaving the proteinaceous fibres of the extrudate substantially intact, wherein:
i) the compressing or compacting is carried out
a) before the proteinaceous phase completes its curing or undergoes a glass transition from the liquid-like to solid state, and/or
b) before the extrudate is allowed to cool and before the extrudate is allowed to dry after the extrusion, and/or
c) while the extrudate is still at an elevated temperature and has an elevated humidity after the extrusion, and/or
d) within 60 s from the extrudate exiting the extruder die, and/or
e) within 48 h from the extrudate exiting the extruder die, if the extrudate is kept in a steaming environment having a temperature and humidity so chosen such that the product neither substantially cools nor substantially dries between exiting the extruder die and the compression or compacting;
ii) the compressing or compacting is sustained over a period that causes an irreversible reduction in the size of the expansion-related cavities between the proteinaceous fibres, and preferably also an increase in the bonding between the proteinaceous fibres.

57. The method according to claim 56, wherein the compressing or compacting is carried out using a compressive rheology pressing method including using rolls, a twin-belt or plates.

58. The method according to claim 56, wherein the compacting/compressing method is selected not to cause shear forces in the bulk material, except shear forces that may result from twisting, and/or is selected not to break the bonding in the proteinaceous fibre matrix; preferably the compacting/compressing is carried out by using rolls, twin-belt or plates.

59. The method according to claim 56, wherein the compressing or compacting is carried out before a change of the melted proteinaceous material from a liquid-like phase to a solid phase and the water from liquid-like water to evaporated water that is present in expansion-related cavities will be completed.

60. The method according to claim 56, wherein the compressing or compacting is carried out before the extrudate is cooled or allowed to cool below 50 C.

61. The method according to claim 56, wherein the compressing or compacting is carried out by causing a pressure greater than 60 psi.

62. The method according to claim 61, wherein the pressure is greater than 85 psi.

63. The method according to claim 61, wherein the pressure is greater than 115 psi.

64. The method according to claim 61, wherein the pressure is greater than 300 psi.

65. The method according to claim 56, wherein the compressing or compacting is set as targeting at a compression gap to be 8-13%, of the thickness of the extrudate before compressing or compacting.

66. The method according to claim 56, wherein the compressing or compacting is set as targeting at a compression gap to be 30-36%, of the extruder die assembly outlet diameter, or of the smallest dimension of the extruder die assembly outlet.

67. The method according to claim 56, wherein the compressing or compacting force is selected so that the compression or compacting is carried out in manner preventing the extrudate to substantially expand after the compression or compacting, such that the expansion of the textured vegetable protein product from 1 min after compressing or compacting to 2 h after compacting or compressing is at most 15% of its thickness.

68. The method according to claim 56, wherein the extrudates from the extruder outlet are separated or kept apart from each other before and the compression or compacting and kept apart during the compression or compacting.

69. The method according to claim 56, wherein the extrudates from the extruder outlet are laminated, stacked, or aggregated in more than one particle or strand before and during the compression or compacting, such that the compression or compacting attaches the extrudates to each other.

70. The method according to claim 56, wherein the extrudate is between exiting the extruder die and the compression or compacting preserved in a steaming environment having a temperature and humidity such that the product does not substantially cool and dry between exiting the extruder die and the compression or compacting.

71. The method according to claim 56, wherein the compression or compacting is carried out in a steaming environment having a temperature and humidity such that the product does not substantially cool and dry between exiting the extruder die and the compression or compacting.

72. The method according to claim 70, wherein the moisture content of the extrudate after the steaming environment is between 80-120% of the original extrudate moisture content before the steaming environment.

73. The method according to claim 56, wherein the compressing or compacting is carried out in a time window after the extrusion during which the proteinaceous fibres are responsive to pressing, such that the expansion of the textured vegetable protein product from 1 min after compressing or compacting to 2 h after compacting or compressing is at most 15% of its thickness.

74. The method according to claim 73, wherein the time window is extended with the steaming environment, and at least one of:
the extrudate is between exiting the extruder die and the compression or compacting preserved in a steaming environment having a temperature and humidity such that the product does not substantially cool and dry between exiting the extruder die and the compression or compacting; and/or
the compression or compacting is carried out in a steaming environment having a temperature and humidity such that the product does not substantially cool and dry between exiting the extruder die and the compression or compacting; and/or
the compressing or compacting is carried out in a time window after the extrusion during which the proteinaceous fibres are responsive to pressing, such that the expansion of the textured vegetable protein product from 1 min after compressing or compacting to 2 h after compacting or compressing is at most 15% of its thickness.

75. The method according to claim 56, wherein the extrudate is compressed or compacted after the extrusion before the hardness (H_{c}) of the extrudate increases to four-fold of the hardness (H₀) measured at 5 s or 15 s after the extrusion.

76. The method according to claim 56, wherein a vegetable protein of the textured vegetable protein product comprises at least one of:
soy protein isolate and/or concentrate, and/or
pea protein isolate and/or concentrate, and/or
faba bean protein isolate and/or concentrate, and/or
lentil protein isolate and/or concentrate, and/or
chick pea protein isolate and/or concentrate, and/or
mung bean protein isolate and/or concentrate, and/or
oat protein isolate and/or concentrate, and/or
rye protein isolate and/or concentrate, and/or
barley protein isolate and/or concentrate, and/or
lupine protein isolate and/or concentrate, and/or
peanut protein isolate and/or concentrate.

77. The method according to claim 56, wherein the extrusion is carried out on a water-based slurry comprising a protein material, flour and/or bran, which preferably comprise starch, and selected from the group consisting of oat flour, oat bran, pea flour, faba bean flour, chickpea flour, corn flour, rice flour.

78. The method according to claim 56, wherein the expansion-related cavities comprising air bubbles, have after the irreversible size reduction a width less than 0.5 mm.

79. The method according to claim 56, wherein the expansion-related cavities comprising air bubbles, have after the irreversible size reduction a cross-sectional area in the thickness and length direction of the textured vegetable protein product such that between 22% and 96% of the expansion-related cavities have a cross-sectional area less than 0.03 mm².

80. The method according to claim 56, wherein the expansion-related cavities comprising air bubbles, have after the irreversible size reduction a width-to-length ration smaller than 22%.

81. The method according to claim 56, wherein the compression is used to achieve a reduced porosity of the textured vegetable protein product.

82. The method according to claim 81, wherein the reduced porosity is defined as a sample of the textured vegetable protein product, when analyzed using X-ray microtomography, having unit regions having high solid fraction values, such as solid fraction value being no less than 70%.

83. The method according to claim 56, wherein the compression is used to produce an uneven, non-homogenous structure in the textured vegetable protein product.

84. The method according to claim 56, wherein the compression is used to increase stability of the proteinaceous fibres.

85. The method according to claim 56, wherein the compression is used to bundle the proteinaceous fibres together, and/or to laminate the proteinaceous fibres between each other.

86. A method of controlling the mouthfeel of a textured vegetable protein product comprising:
preparing an extrudate with an extruder configured to carry out low-moisture protein texturization extrusion, the extrudate comprising a proteinaceous fibre structure having expansion-related cavities, such as air bubbles, between the proteinaceous fibres;
after the extrusion, one of compressing or compacting the extrudate in a manner leaving the proteinaceous fibres of the extrudate substantially intact, wherein:
i) the compressing or compacting is carried out
a) before the proteinaceous phase completes its curing or undergoes a glass transition from the liquid-like to solid state, and/or
b) before the extrudate is allowed to cool and before the extrudate is allowed to dry after the extrusion, and/or
c) while the extrudate is still at an elevated temperature and has an elevated humidity after the extrusion, and/or
d) within 60 s from the extrudate exiting the extruder die, and/or
e) within 48 h from the extrudate exiting the extruder die, if the extrudate is kept in a steaming environment having a temperature and humidity so chosen such that the product neither substantially cools nor substantially dries between exiting the extruder die and the compression or compacting;
ii) the compressing or compacting is sustained over a period that causes an irreversible reduction in the size of the expansion-related cavities between the proteinaceous fibres, and preferably also an increase in the bonding between the proteinaceous fibres, wherein the mouthfeel of a textured vegetable protein product is controlled by causing an irreversible size reduction of expansion-related cavities comprising air bubbles, such that the expansion-related cavities have after the irreversible size reduction a width less than 0.5 mm.

87. The method of controlling the mouthfeel of a textured vegetable protein product according to claim 86, wherein the mouthfeel of a textured vegetable protein product is controlled by causing an irreversible reduction of a cross-sectional area of expansion-related cavities in the thickness and length direction of the textured vegetable protein product, such that between 22% and 96% of the expansion-related cavities has a cross-sectional area less than 0.03 mm².

88. The method of controlling the mouthfeel of a textured vegetable protein product according to claim 86, wherein the mouthfeel of a textured vegetable protein product is controlled by causing an irreversible reduction of a width-to-length ratio in the expansion-related cavities which is smaller than 22%.

89. The method of controlling the mouthfeel of a textured vegetable protein product according to claim 86, wherein the mouthfeel of a textured vegetable protein product is controlled by irreversibly reducing porosity of the textured vegetable protein product by post-extrusion compression of the textured vegetable protein product.

90. The method of controlling the mouthfeel of a textured vegetable protein product according to claim 86, wherein the mouthfeel of a textured vegetable protein product is controlled by generating regions in the textured vegetable protein product having unit regions having high solid fraction values being no less than 70% when analysed using X-ray microtomography.

91. The method of controlling the mouthfeel of a textured vegetable protein product according to claim 86, wherein the mouthfeel of a textured vegetable protein product is controlled by producing, after the textured vegetable protein product is extruded, an uneven, non-homogenous structure in the textured vegetable protein product.

92. The method of controlling the mouthfeel of a textured vegetable protein product according to claim 86, wherein the mouthfeel of a textured vegetable protein product is controlled, after extrusion, by increasing stability of the proteinaceous fibres.

93. The method of controlling the mouthfeel of a textured vegetable protein product according to claim 86, wherein the mouthfeel of a textured vegetable protein product is controlled after extrusion i) by bundling the proteinaceous fibres together and/or ii) laminating the proteinaceous fibres between each other.

94. A textured vegetable protein product, comprising:
an extrudate manufactured with low-moisture protein texturization extrusion, having a proteinaceous fibre structure with expansion-related cavities, such as air bubbles, between the proteinaceous fibres; and
the extrudate has, after the extrusion, been compressed or compacted in a manner leaving the proteinaceous fibres of the extrudate substantially intact but reducing the size of the expansion-related cavities between the proteinaceous fibres, and preferably also increased the bonding between the proteinaceous fibres.

95. The textured vegetable protein product according to claim 94 that is produced according to a method comprising:
preparing an extrudate with an extruder configured to carry out low-moisture protein texturization extrusion, the extrudate comprising a proteinaceous fibre structure having expansion-related cavities, such as air bubbles, between the proteinaceous fibres;
after the extrusion, one of compressing or compacting the extrudate in a manner leaving the proteinaceous fibres of the extrudate substantially intact, wherein:
i) the compressing or compacting is carried out
a) before the proteinaceous phase completes its curing or undergoes a glass transition from the liquid-like to solid state, and/or
b) before the extrudate is allowed to cool and before the extrudate is allowed to dry after the extrusion, and/or
c) while the extrudate is still at an elevated temperature and has an elevated humidity after the extrusion, and/or
d) within 60 s from the extrudate exiting the extruder die, and/or
e) within 48 h from the extrudate exiting the extruder die, if the extrudate is kept in a steaming environment having a temperature and humidity so chosen such that the product neither substantially cools nor substantially dries between exiting the extruder die and the compression or compacting;
ii) the compressing or compacting is sustained over a period that causes an irreversible reduction in the size of the expansion-related cavities between the proteinaceous fibres, and preferably also an increase in the bonding between the proteinaceous fibres.

96. The textured vegetable protein product according to claim 94, wherein the expansion-related cavities have a width-to-length ratio which is smaller than 22%.

97. The textured vegetable protein product, according to claim 94, wherein:
the textured vegetable protein product is an extrudate manufactured with low-moisture protein texturization extrusion, having a proteinaceous fibre structure with expansion-related cavities, such as air bubbles, between the proteinaceous fibres,
and further wherein the expansion-related cavities have after the irreversible size reduction a width less than 0.5 mm.

98. The textured vegetable protein product, according to claim 94, wherein:
the textured vegetable protein product is an extrudate manufactured with low-moisture protein texturization extrusion, having a proteinaceous fibre structure with expansion-related cavities, such as air bubbles, between the proteinaceous fibres, and
wherein between 22% and 96% of the expansion-related cavities have after the irreversible size reduction a cross-sectional area in the thickness and length direction of the textured vegetable protein product which is less than 0.03 mm².

99. The textured vegetable protein product, according to claim 94, wherein:
the textured vegetable protein product is an extrudate manufactured with low-moisture protein texturization extrusion, having a proteinaceous fibre structure with expansion-related cavities, such as air bubbles, between the proteinaceous fibres, and
wherein the textured vegetable protein product has a reduced porosity.

100. The textured vegetable protein product according to claim 99, wherein the textured vegetable protein product has a reduced porosity, when analysed using X-ray microtomography, has unit regions having high solid fraction values, such solid fraction value being no less than 70%.

101. The textured vegetable protein product, preferably according to claim 94, wherein:
the textured vegetable protein product is an extrudate manufactured with low-moisture protein texturization extrusion, having a proteinaceous fibre structure with expansion-related cavities, such as air bubbles, between the proteinaceous fibres, and
wherein the textured vegetable protein product has unit regions having high solid-fraction values when analysed using X-ray microtomography, for example such that the high solid fraction values being no less than 70%.

102. The textured vegetable protein product, preferably according to claim 94, wherein:
the textured vegetable protein product is an extrudate manufactured with low-moisture protein texturization extrusion, having a proteinaceous fibre structure with expansion-related cavities, such as air bubbles, between the proteinaceous fibres, and
wherein the textured vegetable protein product has an uneven, non-homogenous structure in the textured vegetable protein product.

103. The textured vegetable protein product, preferably according to claim 94, wherein:
the textured vegetable protein product is an extrudate manufactured with low-moisture protein texturization extrusion, having a proteinaceous fibre structure with expansion-related cavities between the proteinaceous fibres, and
wherein the proteinaceous fibres have an increased stability.

104. The textured vegetable protein product, preferably according to claim 94, wherein:
the textured vegetable protein product is an extrudate manufactured with low-moisture protein texturization extrusion, having a proteinaceous fibre structure with expansion-related cavities, such as air bubbles, between the proteinaceous fibres,
and further wherein the proteinaceous fibres have been post-extrusion treated i) by bundling the proteinaceous fibres together and/or ii) laminating the proteinaceous fibres between each other.

105. A textured vegetable protein product, which has a fibrous protein structure which during initial biting and cracking in a mouth (stage 1) has a crunchy chewy mouthfeel offering bite-resistance, and during continued chewing and mixing with saliva (stage 2) changes to mouthfeel of muscle-like fibers or fiber-bunches.

106. A textured vegetable protein product, which has a fibrous protein structure which as dry has a crisp-like mouthfeel and as soaked has a mouthfeel of muscle-like fibers or fiber-bunches.

107. The textured vegetable protein product according to claim 105, wherein the thickness of the textured vegetable protein product, is between 0.5 and 2.0 mm.

108. The textured vegetable protein product according to claim 105, wherein the textured vegetable protein product has unit regions having high solid-fraction values when analyzed using X-ray microtomography, being no less than 70%.

109. The textured vegetable protein product according to claim 105, wherein:
the textured vegetable protein product is an extrudate manufactured with low-moisture protein texturization extrusion, having a proteinaceous fibre structure with expansion-related cavities, such as air bubbles, between the proteinaceous fibres;
and further wherein: a substantial proportion-preferably between 22% and 96%—of the expansion-related cavities, such as air bubbles, have after the irreversible size reduction a cross-sectional area in the thickness and length direction of the textured vegetable protein product which is less than 0.03 mm².

110. The textured vegetable protein product according to claim 105, wherein the textured vegetable protein product has a moisture content between 7% and 11% by weight.
